(19) United States
(12) Patent Application Publication
(10) Pub. No.: US 2025/0254345 A1
(43) Pub. Date: Aug. 7, 2025

(54) PRE-ANALYSIS FOR VIDEO ENCODING

(71) Applicant: V-NOVA INTERNATIONAL LIMITED, London (GB)

(72) Inventors: Lorenzo CICCARELLI, London (GB); Florian MAURER, London (GB)

(21) Appl. No.: 18/852,889

(22) PCT Filed: Feb. 27, 2023
(86) PCT No.: PCT/GB2023/050440

§ 371 Date: Sep. 30, 2024

(30) Foreign Application Priority Data
Mar. 31, 2022 (GB) 2204687.4

(51) Int. Cl. H04N 19/196; H04N 19/14; H04N 19/172; H04N 19/33

(52) U.S. Cl. CPC H04N 19/196; H04N 19/14; H04N 19/172; H04N 19/33

(57) ABSTRACT

A method for determining an encoder parameter for encoding an input video comprising a sequence of video frames, the input video having a first resolution, the method comprising: obtaining a first and a second video frame of the input video, wherein the second video frame follows the first video frame in the sequence of video frames; down-sampling the first and second frames to a second resolution to obtain a first and a second down-sampled video frame; generating a detail perception metric based on the first and second down-sampled video frames; determining, based on the detail perception metric, an encoder parameter for encoding the second video frame, wherein the detail perception metric comprises an edge detection metric based on the second down-sampled frame and a motion metric based on a difference between the first and second down-sampled frames.

### TECHNICAL FIELD

The following disclosure relates to video encoding. In particular, the disclosure relates to efficient encoding which improves compressibility while maintaining perceived quality of reconstructed video, by performing pre-analysis before encoding. The following disclosure is particularly applicable to pre-analysis before LCEVC (Low Complexity Enhancement Video Coding) encoding, although the described techniques can be used as pre-analysis before using other standardized encoding techniques.

### BACKGROUND

When encoding and decoding video, it is always necessary to strike a balance between improving compression of the encoded video and improving the fidelity of the decoded video to the original video.

In a simple case, encoder parameters such as a desired bit rate are chosen when configuring a codec, and the chosen encoder parameters are applied for encoding an entire video.

However, it is desirable to configure an encoder more intelligently, to prioritize compression in parts of a video which contain less information and to prioritize fidelity in parts of a video which contain more information, or to ensure that the encoded video meets a set of requirements (e.g. a maximum bit rate) regardless of variations in the information density or other properties of the raw video.

The encoding techniques in the following specification are particularly suited to be used with existing Low Complexity Enhancement Video Coding (LCEVC) techniques.

A standard specification for LCEVC is provided in the Text of ISO/IEC 23094-2 Ed 1 Low Complexity Enhancement Video Coding published in November 2021, and many possible implementation details of LCEVC are described in patent publications WO 2020/188273 and WO 2020/188229. Each of these earlier documents is incorporated here by reference.

Broadly speaking, LCEVC enhances the reproduction fidelity of a decoded video after encoding and decoding using an existing codec. This is achieved by combining a base layer with an enhancement layer, where the base layer contains the video encoded using the existing codec, and the enhancement layer indicates a residual difference between the original video and an expected decoded video produced by decoding the base layer using the existing codec. The enhancement layer can be combined with the decoded base layer to more accurately reproduce the original video.

In the context of LCEVC, the enhancement layer can also be encoded, for example by down-sampling the enhancement layer to a lower resolution or quantizing pixel values of the enhancement layer. As a result, even within the standardized techniques of LCEVC there are a number of encoder parameters which can be adapted to provide an improved compression-fidelity balance.

### SUMMARY

According to a first aspect, there is provided a method for determining an encoder parameter for encoding an input video comprising a sequence of video frames, the input video having a first resolution, the method comprising: obtaining a first video frame of the input video; down-sampling the first frame to a second resolution to obtain a first down-sampled video frame; generating a detail perception metric based on the first down-sampled video frame; determining, based on the detail perception metric, an encoder parameter for encoding the first video frame, wherein the detail perception metric comprises an edge detection metric based on the first down-sampled frame.

Optionally in the first aspect, the edge detection metric comprises a text detection metric.

Optionally in the first aspect, the edge detection metric is calculated by processing the first down-sampled frame using a directional decomposition to generate a set of directional components.

Optionally in the first aspect, the method comprises generating the detail perception metric and determining the encoder parameter for each of a plurality of local blocks of the second down-sampled video frame.

Optionally in the first aspect, the encoder parameter comprises a priority level for encoding resources.

Optionally in the first aspect, the encoder parameter is a parameter for Low Complexity Enhancement Video Coding, LCEVC.

Optionally in the first aspect, the encoder parameter comprises a residual mode selection for encoding a residual in an LCEVC enhancement layer when encoding the first frame.

Optionally in the first aspect, the encoder parameter comprises a decision of whether or not to apply temporal prediction to an LCEVC enhancement layer when encoding the first frame.

Optionally in the first aspect, the encoder parameter comprises a quantization parameter for an LCEVC enhancement layer when encoding the first frame.

According to a second aspect, there is provided a method of encoding an input video comprising a sequence of video frames, the input video having a first resolution, the method comprising: obtaining a first video frame of the input video; performing pre-analysis to determine an encoder parameter for encoding the first video frame, the pre-analysis comprising the method according the first aspect; instructing an encoder to encode the first video frame based on the encoder parameter.

Optionally in the second aspect, the encoder is an LCEVC encoder, and encoding the first video frame comprises: down-sampling the first video frame; encoding the down-sampled first video frame using a base codec to obtain a base encoding layer; decoding the base encoding layer using the base codec to obtain a decoded reference video frame; calculating one or more residuals based on a difference between the first frame and the decoded reference video frame; and encoding the one or more residuals to obtain an enhancement layer, wherein the encoder parameter is a parameter for calculating or encoding one or more of the residuals.

According to a third aspect, there is provided a method for determining an encoder parameter for encoding an input video comprising a sequence of video frames, the input video having a first resolution, the method comprising: obtaining a first and a second video frame of the input video, wherein the second video frame follows the first video frame in the sequence of video frames; down-sampling the first and second frames to a second resolution to obtain a first and a second down-sampled video frame; generating a detail perception metric based on the first and second down-sampled video frames; determining, based on the detail perception metric, an encoder parameter for encoding the second video frame, wherein the detail perception metric comprises an edge detection metric based on the second down-sampled frame and a motion metric based on a difference between the first and second down-sampled frames.

Optionally in the third aspect, the edge detection metric comprises a text detection metric.

Optionally in the third aspect, the edge detection metric is calculated by processing the second down-sampled frame using a directional decomposition to generate a set of directional components.

Optionally in the third aspect, the motion metric comprises a sum of absolute differences between the first down-sampled frame and the second down-sampled frame.

Optionally in the third aspect, the method comprises generating the detail perception metric and determining the encoder parameter for each of a plurality of local blocks of the second down-sampled video frame.

Optionally in the third aspect, the encoder parameter comprises a priority level for encoding resources.

Optionally in the third aspect, the encoder parameter is a parameter for Low Complexity Enhancement Video Coding, LCEVC.

Optionally in the third aspect, the encoder parameter comprises a residual mode selection for encoding a residual in an LCEVC enhancement layer when encoding the second frame.

Optionally in the third aspect, the encoder parameter comprises a decision of whether or not to apply temporal prediction to an LCEVC enhancement layer when encoding the second frame.

Optionally in the third aspect, the encoder parameter comprises a quantization parameter for an LCEVC enhancement layer when encoding the second frame.

According to a fourth aspect, there is provided a method of encoding an input video comprising a sequence of video frames, the input video having a first resolution, the method comprising: obtaining a first and a second video frame of the input video, wherein the second video frame follows the first video frame in the sequence of video frames; performing pre-analysis to determine an encoder parameter for encoding the second video frame, the pre-analysis comprising the method according the third aspect; instructing an encoder to encode the second video frame based on the encoder parameter.

Optionally in the fourth aspect, the encoder is an LCEVC encoder, and encoding the second video frame comprises: down-sampling the second video frame; encoding the down-sampled second video frame using a base codec to obtain a base encoding layer; decoding the base encoding layer using the base codec to obtain a decoded reference video frame; calculating one or more residuals based on a difference between the second frame and the decoded reference video frame; and encoding the one or more residuals to obtain an enhancement layer, wherein the encoder parameter is a parameter for calculating or encoding one or more of the residuals.

According to a fifth aspect, there is provided a device comprising one or more processors and a memory, the memory storing instructions which, when executed by the processors, cause the processors to perform a method according to the first aspect or the third aspect.

According to a sixth aspect, there is provided an encoder configured to perform the method of the first aspect in parallel with the method of the second aspect.

According to a seventh aspect, there is provided an encoder configured to perform the method of the third aspect in parallel with the method of the fourth aspect.

According to an eighth aspect, there is provided a non-transitory computer-readable storage medium storing instructions which, when executed by one or more processors, cause the processors to perform a method according to the first aspect or the third aspect.

According to a ninth aspect, there is provided a non-transitory computer-readable storage medium storing instructions which, when executed by one or more processors, cause the processors to perform a method according to the first aspect in parallel with the method of the second aspect.

According to a tenth aspect, there is provided a non-transitory computer-readable storage medium storing instructions which, when executed by one or more processors, cause the processors to perform a method according to the third aspect in parallel with the method of the fourth aspect.

### BRIEF DESCRIPTION OF THE DRAWINGS

FIG. 1 shows a high-level schematic of an encoding process;

FIG. 2 shows a high-level schematic of a decoding process;

FIG. 3 shows a high-level schematic of an encoding process and specific encoding steps;

FIG. 4 shows a high-level schematic of a decoding process and specific decoding steps;

FIG. 5 shows a high-level schematic of an encoding process and residual processing;

FIG. 6 shows a high-level schematic of a further decoding process;

FIG. 7 shows a high-level schematic of an encoding process and residual mode control;

FIG. 8 shows classification and residuals weighting;

FIG. 9 illustrates a decoding process which uses temporal prediction;

FIGS. 10a to 10c shows interaction between a pre-analysis module and an encoder;

FIG. 11 is a block diagram showing detail of a pre-analysis module in an embodiment;

FIG. 12 is a flow chart schematically illustrating a method according to an embodiment;

FIG. 13 is a flow chart schematically illustrating a method according to an embodiment.

### DETAILED DESCRIPTION

Before discussing the encoder parameter pre-analysis techniques of the present invention, the following provides a discussion of a coding technology with which the determined encoder parameter may be used. This also explains much of the terminology used in the encoder parameter pre-analysis techniques. Such a coding technology has been previously described in, for example, WO 2020/188229.

The pre-analysis techniques discussed herein may be used with a flexible, adaptable, highly efficient and computationally inexpensive coding technology and format which combines a video coding format, a base codec, (e.g. AVC, HEVC, or any other present or future codec) with an enhancement level of coded data, encoded using a different technique. The technology uses a down-sampled source signal encoded using a base codec to form a base stream. An enhancement stream is formed using an encoded set of residuals which correct or enhance the base stream for example by increasing resolution or by increasing frame rate. There may be multiple levels of enhancement data in a hierarchical structure. In certain arrangements, the base stream may be decoded by a hardware decoder while the enhancement stream may be suitable for a software implementation.

It is important that any optimisation used in the coding technology is tailored to the specific requirements or constraints of the enhancement stream and is of low complexity. Such requirements or constraints include: the potential reduction in computational capability resulting from the need for software decoding of the enhancement stream; the need for combination of a decoded set of residuals with a decoded frame; the likely structure of the residual data, i.e. the relatively high proportion of zero values with highly variable data values over a large range; the nuances of a quantized block of coefficients; and, the structure of the enhancement stream being a set of discrete residual frames separated into various components. Note that the constraints placed on the enhancement stream mean that a simple and fast entropy coding operation is essential to enable the enhancement stream to effectively correct or enhance individual frames of the base decoded video. Note that in some scenarios the base stream is also being decoded substantially simultaneously before combination, putting a strain on resources.

In one case, the methods described herein may be applied to so-called planes of data that reflect different colour components of a video signal. For example, the methods described herein may be applied to different planes of YUV or RGB data reflecting different colour channels. Different colour channels may be processed in parallel. Hence, references to sets of residuals as described herein may comprise multiple sets of residuals, where each colour component has a different set of residuals that form part of a combined enhancement stream. The components of each stream may be collated in any logical order, for example, each plane at the same level may be grouped and sent together or, alternatively, the sets of residuals for different levels in each plane may be sent together.

This present document preferably fulfils the requirements of the following ISO/IEC documents: “Call for Proposals for Low Complexity Video Coding Enhancements” ISO/IEC JTC1/SC29/WG11 N17944, Macao, CN, October 2018 and “Requirements for Low Complexity Video Coding Enhancements” ISO/IEC JTC1/SC29/WG11 N18098, Macao, CN, October 2018 (which are incorporated by reference herein). Moreover, approaches described herein may be incorporated into products as supplied by V-Nova International Ltd.

The general structure of an encoding scheme in which the presently described techniques can be applied, uses a down-sampled source signal encoded with a base codec, adds a first level of correction data to the decoded output of the base codec to generate a corrected picture, and then adds a further level of enhancement data to an up-sampled version of the corrected picture. Thus, the streams are considered to be a base stream and an enhancement stream. This structure creates a plurality of degrees of freedom that allow great flexibility and adaptability to many situations, thus making the coding format suitable for many use cases including Over-The-Top (OTT) transmission, live streaming, live Ultra High Definition (UHD) broadcast, and so on. Although the decoded output of the base codec is not intended for viewing, it is a fully decoded video at a lower resolution, making the output compatible with existing decoders and, where considered suitable, also usable as a lower resolution output. In certain cases, a base codec may be used to create a base stream. The base codec may comprise an independent codec that is controlled in a modular or “black box” manner. The methods described herein may be implemented by way of computer program code that is executed by a processor and makes function calls upon hardware and/or software implemented base codecs.

In general, the term “residuals” as used herein refers to a difference between a value of a reference array or reference frame and an actual array or frame of data.

The array may be a one or two-dimensional array that represents a coding unit. For example, a coding unit may be a 2×2 or 4×4 set of residual values that correspond to similar sized areas of an input video frame. It should be noted that this generalised example is agnostic as to the encoding operations performed and the nature of the input signal. Reference to “residual data” as used herein refers to data derived from a set of residuals, e.g. a set of residuals themselves or an output of a set of data processing operations that are performed on the set of residuals. Throughout the present description, generally a set of residuals includes a plurality of residuals or residual elements, each residual or residual element corresponding to a signal element, that is, an element of the signal or original data. The signal may be an image or video. In these examples, the set of residuals corresponds to an image or frame of the video, with each residual being associated with a pixel of the signal, the pixel being the signal element. Examples disclosed herein describe how these residuals may be modified (i.e. processed) to impact the encoding pipeline or the eventually decoded image while reducing overall data size. Residuals or sets may be processed on a per residual element (or residual) basis, or processed on a group basis such as per tile or per coding unit where a tile or coding unit is a neighbouring subset of the set of residuals. In one case, a tile may comprise a group of smaller coding units. A tile may comprise a 16×16 set of picture elements or residuals (e.g. an 8 by 8 set of 2×2 coding units or a 4 by 4 set of 4×4 coding units). Note that the processing may be performed on each frame of a video or on only a set number of frames in a sequence.

In general, each or both enhancement streams may be encapsulated into one or more enhancement bitstreams using a set of Network Abstraction Layer Units (NALUs). The NALUs are meant to encapsulate the enhancement bitstream in order to apply the enhancement to the correct base reconstructed frame. The NALU may for example contain a reference index to the NALU containing the base decoder reconstructed frame bitstream to which the enhancement has to be applied. In this way, the enhancement can be synchronised to the base stream and the frames of each bitstream combined to produce the decoded output video (i.e. the residuals of each frame of enhancement level are combined with the frame of the base decoded stream). A group of pictures may represent multiple NALUs.

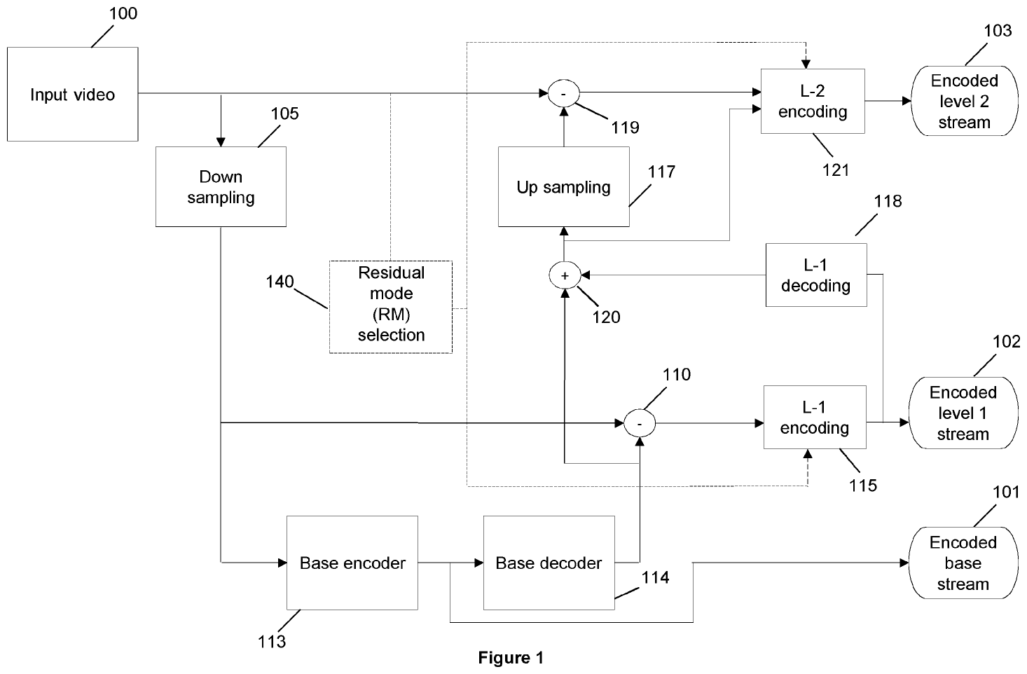

Returning to the initial process described above, where a base stream is provided along with two levels (or sub-levels) of enhancement within an enhancement stream, an example of a generalised encoding process is depicted in the block diagram of FIG. 1. An input full resolution video 100 is processed to generate various encoded streams 101, 102, 103. A first encoded stream (encoded base stream) is produced by feeding a base codec (e.g., AVC, HEVC, or any other codec) with a down-sampled version of the input video. The encoded base stream may be referred to as the base layer or base level. A second encoded stream (encoded level 1 stream) is produced by processing the residuals obtained by taking the difference between a reconstructed base codec video and the down-sampled version of the input video. A third encoded stream (encoded level 2 stream) is produced by processing the residuals obtained by taking the difference between an up-sampled version of a corrected version of the reconstructed base coded video and the input video. In certain cases, the components of FIG. 1 may provide a general low complexity encoder. In certain cases, the enhancement streams may be generated by encoding processes that form part of the low complexity encoder and the low complexity encoder may be configured to control an independent base encoder and decoder (e.g. as packaged as a base codec). In other cases, the base encoder and decoder may be supplied as part of the low complexity encoder. In one case, the low complexity encoder of FIG. 1 may be seen as a form of wrapper for the base codec, where the functionality of the base codec may be hidden from an entity implementing the low complexity encoder.

A down-sampling operation illustrated by downsampling component 105 may be applied to the input video to produce a down-sampled video to be encoded by a base encoder 113 of a base codec. The down-sampling can be done either in both vertical and horizontal directions, or alternatively only in the horizontal direction.

The base encoder 113 and a base decoder 114 may be implemented by a base codec (e.g. as different functions of a common codec). The base codec, and/or one or more of the base encoder 113 and the base decoder 114 may comprise suitably configured electronic circuitry (e.g. a hardware encoder/decoder) and/or computer program code that is executed by a processor.

Each enhancement stream encoding process may not necessarily include an up-sampling step. In FIG. 1 for example, the first enhancement stream is conceptually a correction stream while the second enhancement stream is up-sampled to provide a level of enhancement.

Looking at the process of generating the enhancement streams in more detail, to generate the encoded Level 1 stream, the encoded base stream is decoded by the base decoder 114 (i.e. a decoding operation is applied to the encoded base stream to generate a decoded base stream). Decoding may be performed by a decoding function or mode of a base codec. The difference between the decoded base stream and the down-sampled input video is then created at a level 1 comparator 110 (i.e. a subtraction operation is applied to the down-sampled input video and the decoded base stream to generate a first set of residuals). The output of the comparator 110 may be referred to as a first set of residuals, e.g. a surface or frame of residual data, where a residual value is determined for each picture element at the resolution of the base encoder 113, the base decoder 114 and the output of the downsampling block 105.

The difference is then encoded by a first encoder 115 (i.e. a level 1 encoder) to generate the encoded Level 1 stream 102 (i.e. an encoding operation is applied to the first set of residuals to generate a first enhancement stream).

As noted above, the enhancement stream may comprise a first level of enhancement 102 and a second level of enhancement 103. The first level of enhancement 102 may be considered to be a corrected stream, e.g. a stream that provides a level of correction to the base encoded/decoded video signal at a lower resolution than the input video 100. The second level of enhancement 103 may be considered to be a further level of enhancement that converts the corrected stream to the original input video 100, e.g. that applies a level of enhancement or correction to a signal that is reconstructed from the corrected stream.

In the example of FIG. 1, the second level of enhancement 103 is created by encoding a further set of residuals. The further set of residuals are generated by a level 2 comparator 119. The level 2 comparator 119 determines a difference between an up-sampled version of a decoded level 1 stream, e.g. the output of an upsampling component 117, and the input video 100. The input to the upsampling component 117 is generated by applying a first decoder (i.e. a level 1 decoder) to the output of the first encoder 115. This generates a decoded set of level 1 residuals. These are then combined with the output of the base decoder 114 at summation component 120. This effectively applies the level 1 residuals to the output of the base decoder 114. It allows for losses in the level 1 encoding and decoding process to be corrected by the level 2 residuals. The output of summation component 120 may be seen as a simulated signal that represents an output of applying level 1 processing to the encoded base stream 101 and the encoded level 1 stream 102 at a decoder.

As noted, an up-sampled stream is compared to the input video which creates a further set of residuals (i.e. a difference operation is applied to the up-sampled re-created stream to generate a further set of residuals). The further set of residuals are then encoded by a second encoder 121 (i.e. a level 2 encoder) as the encoded Level 2 enhancement stream (i.e. an encoding operation is then applied to the further set of residuals to generate an encoded further enhancement stream).

Thus, as illustrated in FIG. 1 and described above, the output of the encoding process is a base stream 101 and one or more enhancement streams 102, 103 which preferably comprise a first level of enhancement and a further level of enhancement. The three streams 101, 102 and 103 may be combined, with or without additional information such as control headers, to generate a combined stream for the video encoding framework that represents the input video 100. It should be noted that the components shown in FIG. 1 may operate on blocks or coding units of data, e.g. corresponding to 2×2 or 4×4 portions of a frame at a particular level of resolution. The components operate without any inter-block dependencies, hence they may be applied in parallel to multiple blocks or coding units within a frame. This differs from comparative video encoding schemes wherein there are dependencies between blocks (e.g. either spatial dependencies or temporal dependencies). The dependencies of comparative video encoding schemes limit the level of parallelism and require a much higher complexity.

FIG. 1 illustrates a residual mode selection block 140. If residual mode (RM) has been selected, residuals are processed (i.e. modified and/or ranked and selected) in order to determine which residuals should be transformed and encoded, i.e. which residuals are to be processed by the first and/or second encoders 115 and 121. Preferably this processing is performed prior to entropy encoding. Residual Mode selection 140 is an optional step that may configure or activate processing or modification of residuals i.e. residual processing is performed according to a selected mode. For example, the “residual mode (RM)” may correspond to a residual pre-processing mode, wherein residuals for enhancement layers are pre-processed prior to encoding. It should be noted that the residual pre-processing may be used independently from the encoder parameter pre-processing discussed below. This mode may be turned on and off depending on requirements. For example, the residual mode may be configured via one or more control headers or fields, and the residual mode is an example of the encoder parameter which can be determined using the encoder parameter pre-processing. In alternative embodiments, the residuals may always be modified (i.e. pre-processed) and so selection of a mode is not required. In this case, residual pre-processing may be hard-coded. Examples of residuals processing will be described in detail below. The residual mode, if selected, may act to filter residuals within one or more of the level 1 and level 2 encoding operations, preferably at a stage prior to the encoding sub-components.

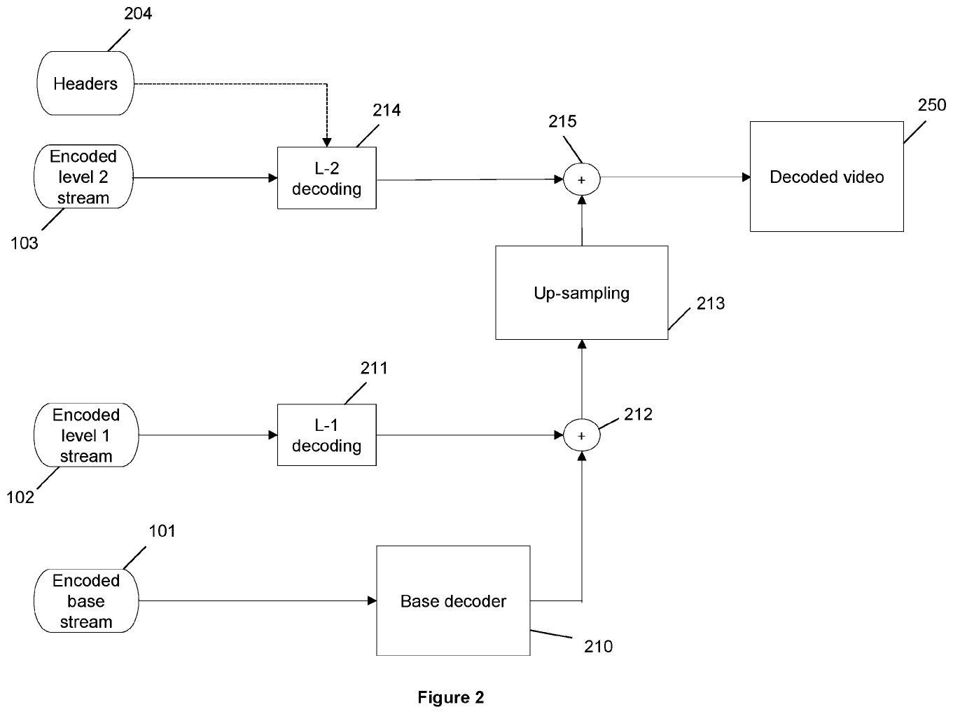

A corresponding generalised decoding process is depicted in the block diagram of FIG. 2. FIG. 2 may be said to show a low complexity decoder that corresponds to the low complexity encoder of FIG. 1. The low complexity decoder receives the three streams 101, 102, 103 generated by the low complexity encoder together with headers 204 containing further decoding information. The headers 204 may include the encoder parameter determined using the encoder parameter pre-analysis described below. The encoded base stream 101 is decoded by a base decoder 210 corresponding to the base codec used in the low complexity encoder. The encoded level 1 stream 102 is received by a first decoder 211 (i.e. a level 1 decoder), which decodes a first set of residuals as encoded by the first encoder 115 of FIG. 1. At a first summation component 212, the output of the base decoder 210 is combined with the decoded residuals obtained from the first decoder 211. The combined video, which may be said to be a level 1 reconstructed video signal, is up-sampled by upsampling component 213. The encoded level 2 stream 103 is received by a second decoder 214 (i.e. a level 2 decoder). The second decoder 214 decodes a second set of residuals as encoded by the second encoder 121 of FIG. 1. Although the headers 204 are shown in FIG. 2 as being used by the second decoder 214, they may also be used by the first decoder 211 as well as the base decoder 210. The output of the second decoder 214 is a second set of decoded residuals. These may be at a higher resolution to the first set of residuals and the input to the upsampling component 213. At a second summation component 215, the second set of residuals from the second decoder 214 are combined with the output of the upsampling component 213, i.e. an upsampled reconstructed level 1 signal, to reconstruct decoded video 250.

As per the low complexity encoder, the low complexity decoder of FIG. 2 may operate in parallel on different blocks or coding units of a given frame of the video signal. Additionally, decoding by two or more of the base decoder 210, the first decoder 211 and the second decoder 214 may be performed in parallel. This is possible as there are no inter-block dependencies.

In the decoding process, the decoder may parse the headers 204 (which may contain global configuration information, picture or frame configuration information, and data block configuration information) and configure the low complexity decoder based on those headers. In order to re-create the input video, the low complexity decoder may decode each of the base stream, the first enhancement stream and the further or second enhancement stream. The frames of the stream may be synchronised and then combined to derive the decoded video 250. The decoded video 250 may be a lossy or lossless reconstruction of the original input video 100 depending on the configuration of the low complexity encoder and decoder. In many cases, the decoded video 250 may be a lossy reconstruction of the original input video 100 where the losses have a reduced or minimal effect on the perception of the decoded video 250.

In each of FIGS. 1 and 2, the level 2 and level 1 encoding operations may include the steps of transformation, quantization and entropy encoding (e.g. in that order). Similarly, at the decoding stage, the residuals may be passed through an entropy decoder, a de-quantizer and an inverse transform module (e.g. in that order). Any suitable encoding and corresponding decoding operation may be used. Preferably however, the level 2 and level 1 encoding steps may be performed in software (e.g. as executed by one or more central or graphical processing units in an encoding device).

The transform as described herein may use a directional decomposition transform such as a Hadamard-based transform. Both may comprise a small kernel or matrix that is applied to flattened coding units of residuals (i.e. 2×2 or 4×4 blocks of residuals). More details on the transform can be found for example in patent applications PCT/EP2013/059847 or PCT/GB2017/052632, which are incorporated herein by reference. The encoder may select between different transforms to be used, for example between a size of kernel to be applied.

The transform may transform the residual information to four surfaces. For example, the transform may produce the following components: average, vertical, horizontal and diagonal.

In summary, the methods and apparatuses herein are based on an overall approach which is built over an existing encoding and/or decoding algorithm (such as MPEG standards such as AVC/H.264, HEVC/H.265, etc. as well as non-standard algorithm such as VP9, AV1, and others) which works as a baseline for an enhancement layer which works accordingly to a different encoding and/or decoding approach. The idea behind the overall approach of the examples is to hierarchically encode/decode the video frame as opposed to the use block-based approaches as used in the MPEG family of algorithms. Hierarchically encoding a frame includes generating residuals for the full frame, and then a decimated frame and so on.

The video compression residual data for the full-sized video frame may be referred to as LoQ-2 (e.g. 1920×1080 for an HD video frame), while that of the decimated frame may be referred to as LoQ-x, where x denotes a number corresponding to a hierarchical decimation. In the described examples of FIGS. 1 and 2, the variable x may have values of 1 and 2 represent the first and second enhancement streams. Hence there are 2 hierarchical levels for which compression residuals will be generated. Other naming schemes for the levels may also be applied without any change in functionality (e.g. the level 1 and level 2 enhancement streams described herein may alternatively be referred to as level 1 and level 2 streams-representing a count down from the highest resolution).

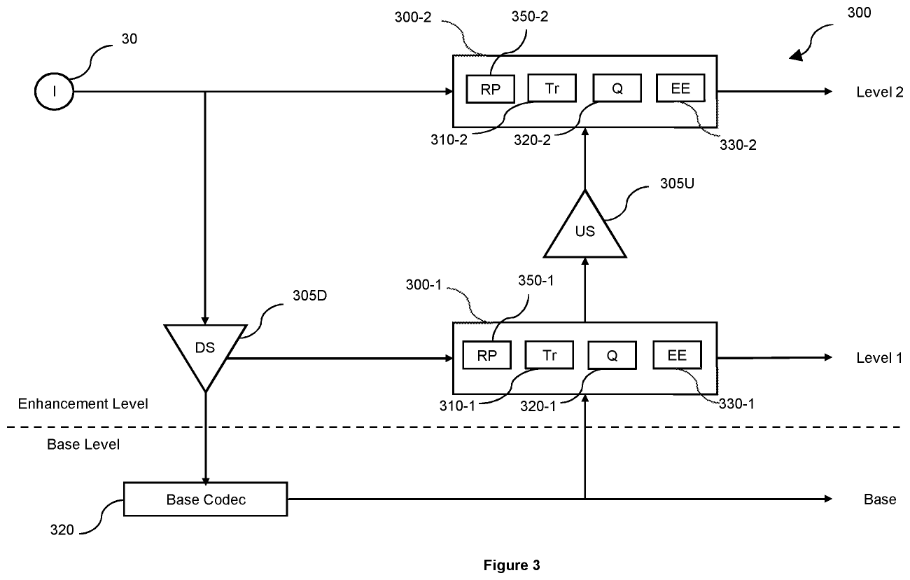

A more detailed encoding process is depicted in the block diagram of FIG. 3. The encoding process is split into two halves as shown by the dashed line. Below the dashed line is the base level of an encoder 300, which may usefully be implemented in hardware or software. Above the dashed line is the enhancement level, which may usefully be implemented in software. The encoder 300 may comprise only the enhancement level processes, or a combination of the base level processes and enhancement level processes as needed. The encoder 300 may usefully be implemented in software, especially at the enhancement level. This arrangement allows, for example, a legacy hardware encoder that provides the base level to be upgraded using a firmware (e.g. software) update, where the firmware is configured to provide the enhancement level. In newer devices, both the base level and the enhancement level may be provided in hardware and/or a combination of hardware and software.

The encoder topology at a general level is as follows. The encoder 300 comprises an input I for receiving an input signal 30. The input signal 30 may comprise an input video signal, where the encoder is applied on a frame-by-frame basis. The input I is connected to a down-sampler 305D and processing block 300-2. The down-sampler 305D may correspond to the downsampling component 105 of FIG. 1 and the processing block 300-2 may correspond to the second encoder 121 of FIG. 1, The down-sampler 305D outputs to a base codec 320 at the base level of the encoder 300. The base codec 320 may implement the base encoder 113 and the base decoder 114 of FIG. 1. The down-sampler 305D also outputs to processing block 300-1. The processing block 300-1 may correspond to the first encoder 115 of FIG. 1. Processing block 300-1 passes an output to an up-sampler 305U, which in turn outputs to the processing block 300-2. The upsampler 305U may correspond to the upsampling component 117 of FIG. 1. Each of the processing blocks 300-2 and 300-1 comprise one or more of the following modules: a transform block 310, a quantization block 320, an entropy encoding block 330 and a residual processing block 350. The residual block 350 may occur prior to the transform block 310 and/or control residual processing in the processing blocks 300. The order of processing may be as set out in the Figures.

The input signal 30, such as in this example a full (or highest) resolution video, is processed by the encoder 300 to generate various encoded streams. A base encoded stream is produced by feeding the base codec 320 (e.g., AVC, HEVC, or any other codec) at the base level with a down-sampled version of the input video 30, using the down-sampler 305D. The base encoded stream may comprise the output of a base encoder of the base codec 320. A first encoded stream (an encoded level 1 stream) is created by reconstructing the encoded base stream to create a base reconstruction, and then taking the difference between the base reconstruction and the down-sampled version of the input video 30.

Reconstructing the encoded base stream may comprise receiving a decoded base stream from the base codec (i.e. the input to processing block 300-1 comprises a base decoded stream as shown in FIG. 1). The difference signal is then processed at block 300-1 to create the encoded level 1 stream. Block 300-1 comprises a transform block 310-1, a quantization block 320-1 and an entropy encoding block 330-1. A second encoded stream (an encoded level 2 stream) is created by up-sampling a corrected version of the base reconstruction, using the up-sampler 305U, and taking the difference between the corrected version of the base reconstruction and the input signal 30. This difference signal is then processed at block 300-2 to create the encoded level 2 stream. Block 300-2 comprises a transform block 310-2, a quantization block 320-2, an entropy encoding block 330-2 and a residual processing block 350-2. As per processing block 300-1, the blocks may be performed in the order shown in the Figures (e.g. residual processing followed by transformation followed by quantization followed by entropy encoding).

Any known quantization scheme may be useful to create the residual signals into quanta, so that certain variables can assume only certain discrete magnitudes. In one case quantizing comprises actioning a division by a pre-determined step-width. This may be applied at both levels (1 and 2). For example, quantizing at block 320 may comprise dividing transformed residual values by a step-width. The step-width may be pre-determined, e.g. selected based on a desired level of quantization. In one case, division by a step-width may be converted to a multiplication by an inverse step-width, which may be more efficiently implemented in hardware. In this case, de-quantizing, such as at block 320, may comprise multiplying by the step-width. Entropy encoding as described herein may comprise run length encoding (RLE), then processing the encoded output is processed using a Huffman encoder. In certain cases, only one of these schemes may be used when entropy encoding is desirable.

The encoded base stream may be referred to as the base level stream.

FIG. 3 illustrates the residual processing blocks 350-2, 350-1 which are located prior to transformation block 310. Although residual processing is shown prior to transformation, optionally, the processing step may be arranged elsewhere, for example, later in the encoding process; however, when being located before the transformation step, residual processing may have the biggest impact throughout the encoding pipeline as efficiencies are propagated through the pipeline. For example, if residual values are filtered at an early stage (e.g. by setting to 0), then this reduces an amount of computation that needs to be performed at subsequent stages within the processing blocks 300. The residual processing block 350 may be activated or configured by residual mode selection block 140 (not shown in FIG. 3, shown in FIG. 1). For example, if a residual mode is selected (e.g. turned on), then the residual processing block 350 may be activated. The residual mode may be selected independently for the first and second enhancement streams (e.g. residual processing blocks 350-2 and 350-1 may be activated and applied separately where one may be off while another is on).

The residual processing block is configured to modify a set of residuals. Certain specific functionality of the residual processing block 310 is described in detail below however, conceptually, the residual processing block 310 functions to modify the residuals. This may be seen as a form of filtering or pre-processing. In certain examples, the residuals may be ranked or given a priority as part of the filtering or pre-processing, whereby those with a higher rank or priority are passed for further processing while those with a lower rank or priority are not passed for further processing (e.g. are set to 0 or a corresponding low value). In effect, the residual processing block is configured to ‘kill’ one or more residuals prior to transformation such that transformation operates on a subset of the residuals.

The residual processing block 310 may be the same in the L2 and L1 pathways or may be configured differently (or not included in a particular pathway) so as to reflect the different nature of those streams.

Certain examples may implement different residual processing modes. A residual mode selection block 140 may indicate whether or not residuals are to be processed and also, in certain embodiments, the type of processing performed. In general, an encoder (such as the low complexity encoder of FIG. 1 or the encoder 300 of FIG. 3) may comprise a residual mode control component 140 that selects and implements a residual mode and residual mode implementation components that implements processing for a selected residual mode in relation to the one or more enhancement streams. In other cases, only residual processing blocks 350 may be provided within each level of enhancement encoding without higher control functionality (e.g. within higher level control component such as control component 140). In this latter case, the functionality of the residual mode control component 140 may be seen to be incorporated into the first and/or second encoders 115 and 121 of FIG. 1.

Examples of residual modes that may be implemented include, but are not limited to a mode where no residual processing is performed, a binary mode whereby certain residuals are multiplied by 0 or 1, a weighting mode whereby residuals are multiplied by a weighting factor, a control mode whereby certain blocks or coding units are not to be processed (e.g. equivalent to setting all residual values in a 2×2 or 4×4 coding unit to 0), a ranking or priority mode whereby residuals are ranked or given a priority within a list and selected for further processing based on the rank or priority, a scoring mode whereby residuals are given a score that is used to configure residual encoding and a categorization mode whereby residuals and/or picture elements are categorised and corresponding residuals are modified or filtered based on the categorization.

As indicated herein, once the residuals have been computed (e.g. by comparators 110 and/or 119 in FIG. 1), the residuals may be processed to decide how the residuals are to be encoded and transmitted. As described earlier, residuals are computed by comparing an original form of an image signal with a reconstructed form of an image signal. For example, in one case, residuals for an L-2 enhancement stream are determined by subtracting an output of the upsampling from an original form of an image signal (e.g. the input video as indicated in the Figures). The input to the upsampling may be said to be a reconstruction of a signal following a simulated decoding. In another case, residuals for an L-1 enhancement stream are determined by subtracting an image stream output by the base decoder from a downsampled form of the original image signal (e.g. the output of the downsampling).

In one residual mode, a decision may be made as to whether to encode and transmit a given set of residuals. For example, in one residual mode, certain residuals (and/or residual blocks-such as the 2×2 or 4×4 blocks described herein) may be selectively forwarded along the L-2 or L-1 enhancement processing pipelines by the ranking components and/or the selection components. Put another way, different residual modes may have different residual processing in the L-2 and L-1 encoding components in FIG. 1. For example, in one residual mode, certain residuals may not be forwarded for further L-2 or L-1 encoding, e.g. may not be transformed, quantized and entropy encoded. In one case, certain residuals may not be forwarded by setting the residual value to 0 and/or by setting a particular control flag relating to the residual or a group that includes the residual.

Control flags will be discussed in more detail below.

In one residual mode, a binary weight of 0 or 1 may be applied to residuals, e.g. by the components discussed above. This may correspond to a mode where selective residual processing is “on”. In this mode, a weight of 0 may correspond to “ignoring” certain residuals, e.g. not forwarding them for further processing in an enhancement pipeline. In another residual mode, there may be no weighting (or the weight may be set to 1 for all residuals); this may correspond to a mode where selective residual processing is “off”. In yet another residual mode, a normalised weight of 0 to 1 may be applied to a residual or group of residuals. This may indicate an importance or “usefulness” weight for reconstructing a video signal at the decoder, e.g. where 1 indicates that the residual has a normal use and values below 1 reduce the importance of the residual. In other cases, the normalised weight may be in another range, e.g. a range of 0 to 2 may give prominence to certain residuals that have a weight greater than 1.

In the residual modes described above, the residual and/or group of residuals may be multiplied by an assigned weight, where the weight may be assigned following a categorization process applied to a set of corresponding elements and/or groups of elements. For example, in one case, each element or group of elements may be assigned a class represented by an integer value selected from a predefined set or range of integers (e.g. 10 classes from 0 to 9). Each class may then have a corresponding weight value (e.g. 0 for class 0, 0.1 for class 1 or some other non-linear mapping). The relationship between class and weight value may be determined by analysis and/or experimentation, e.g. based on picture quality measurements at a decoder and/or within the encoder. The weight may then be used to multiply a corresponding residual and/or group of residuals, e.g. a residual and/or group of residuals that correspond to the element and/or group of elements.

In one case, this correspondence may be spatial, e.g. a residual is computed based on a particular input element value and the categorisation is applied to the particular input element value to determine the weight for the residual. In other words, the categorization may be performed over the elements and/or group of elements of the input image, where the input image may be a frame of a video signal, but then the weights determined from this categorization are used to weight co-located residuals and/or group of residuals rather than the elements and/or group of elements. In this way, the characterization may be performed as a separate process from the encoding process, and therefore it can be computed in parallel to the encoding of the residuals process.

It was described above how certain residuals may not be forwarded by setting the residual value to 0 and/or by setting a particular control flag relating to the residual or a group that includes the residual. In the latter case, a set of flags or binary identifiers may be used, each corresponding to an element or group of elements of the residuals. Each residual may be compared to the set of flags and prevented from being transformed based on the flags. In this way the residuals processing may be non-destructive. Alternatively the residuals may be deleted based on the flags. The set of flags is further advantageous as it may be used repeatedly for residuals or groups of residuals without having to process each set or residual independently and can be used as a reference. For example, each frame may have a binary bitmap that acts a mask to indicate whether a residual is to be processed and encoded. In this case, only residuals that have a corresponding mask value of 1 may be encoded and residuals that have a corresponding mask value of 0 may be collectively set to 0.

In a ranking and filtering mode, the set of residuals may be assigned a priority or rank, which is then compared to a threshold to determine which residuals should be de-selected or ‘killed’. The threshold may be predetermined or may be variable according to a desired picture quality, transmission rate or computing efficiency. For example, the priority or rank may be a value within a given range of values e.g. floating point values between 0 to 1 or integer values between 0 and 255. The higher end of the range (e.g. 1 or 255) may indicate a highest rank or priority. In this case, a threshold may be set as a value within the range. In a comparison, residuals with corresponding rank or priority values below the threshold may be de-selected (e.g. set to 0).

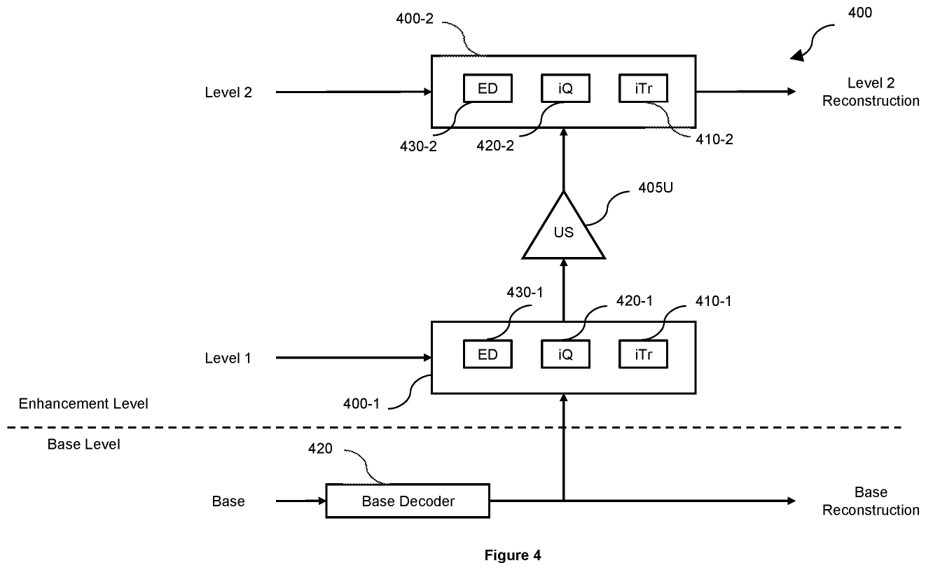

A decoder 400 that performs a decoding process corresponding to the encoder of FIG. 3 is depicted in the block diagram of FIG. 4. The decoding process is split into two halves as shown by the dashed line. Below the dashed line is the base level of the decoder 400, which may usefully be implemented in hardware. Above the dashed line is the enhancement level, which may usefully be implemented in software. The decoder 400 may comprise only the enhancement level processes, or a combination of the base level processes and enhancement level processes as needed. The decoder 400 may usefully be implemented in software, especially at the enhancement level, and may suitably sit over legacy decoding technology, particularly legacy hardware technology. By legacy technology, it is meant older technology previously developed and sold which is already in the marketplace, and which would be inconvenient and/or expensive to replace, and which may still serve a purpose for decoding signals. In other cases, the base level may comprise any existing and/or future video encoding tool or technology.

The decoder topology at a general level is as follows. The decoder 400 comprises an input (not shown) for receiving one or more input signals comprising the encoded base stream, the encoded level 1 stream, and the encoded level 2 stream together with optional headers containing further decoding information. The decoder 400 comprises a base decoder 420 at the base level, and processing blocks 400-1 and 400-2 at the enhancement level. An up-sampler 405U is also provided between the processing blocks 400-1 and 400-2 to provide processing block 400-2 with an up-sampled version of a signal output by processing block 400-1. The base decoder 420 may correspond to the base decoder 210 of FIG. 2, the processing block 400-1 may correspond to the first decoder 211 of FIG. 2, the processing block 400-2 may correspond to the second decoder 214 of FIG. 2 and the upsampler 405U may correspond to the upsampler 213 of FIG. 2.

The decoder 400 receives the one or more input signals and directs the three streams generated by the encoder 300. The encoded base stream is directed to and decoded by the base decoder 420, which corresponds to the base codec 420 used in the encoder 300, and which acts to reverse the encoding process at the base level. The encoded level 1 stream is processed by block 400-1 of decoder 400 to recreate the first set of residuals created by encoder 300. Block 400-1 corresponds to the processing block 300-1 in encoder 300, and at a basic level acts to reverse or substantially reverse the processing of block 300-1. The output of the base decoder 420 is combined with the first set of residuals obtained from the encoded level 1 stream. The combined signal is up-sampled by up-sampler 405U. The encoded level 2 stream is processed by block 400-2 to recreate the further residuals created by the encoder 300. Block 400-2 corresponds to the processing block 300-2 of the encoder 300, and at a basic level acts to reverse or substantially reverse the processing of block 300-2. The up-sampled signal from up-sampler 405U is combined with the further residuals obtained from the encoded level 2 stream to create a level 2 reconstruction of the input signal 30.

The output of the processing block 400-2 may be seen as decoded video similar to the decoded video 250 of FIG. 2.

As noted above, the enhancement stream may comprise two streams, namely the encoded level 1 stream (a first level of enhancement) and the encoded level 2 stream (a second level of enhancement). The encoded level 1 stream provides a set of correction data which can be combined with a decoded version of the base stream to generate a corrected picture.

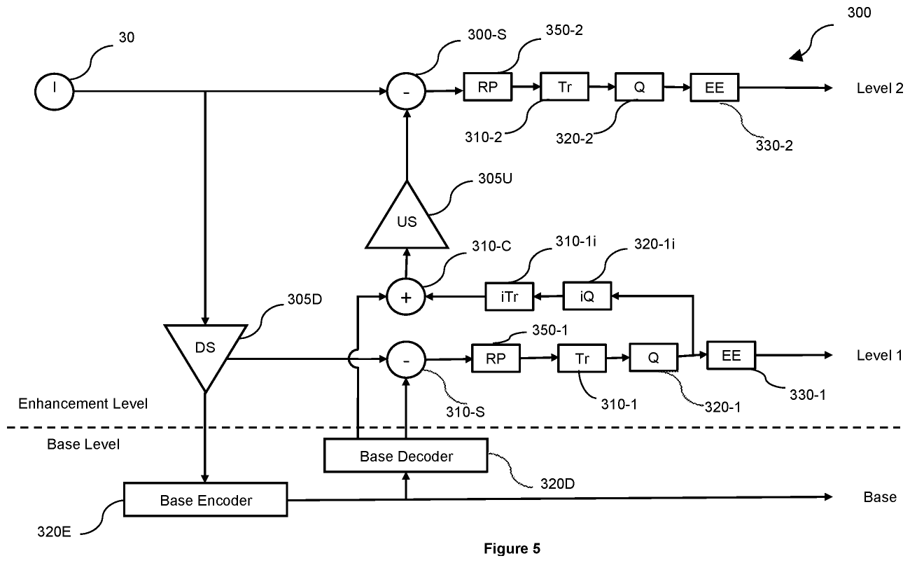

FIG. 5 shows the encoder 300 of FIG. 1 in more detail. The encoded base stream is created directly by the base encoder 320E, and may be quantized and entropy encoded as necessary. In certain cases, these latter processes may be performed as part of the encoding by the base encoder 320E. To generate the encoded level 1 stream, the encoded base stream is decoded at the encoder 300 (i.e. a decoding operation is applied at base decoding block 320D to the encoded base stream). The base decoding block 320D is shown as part of the base level of the encoder 300 and is shown separate from the corresponding base encoding block 320E. For example, the base decoder 320D may be a decoding component that complements an encoding component in the form of the base encoder 320E with a base codec. In other examples, the base decoding block 320D may instead be part of the enhancement level and in particular may be part of processing block 300-1.

Returning to FIG. 5, a difference between the decoded base stream output from the base decoding block 320D and the down-sampled input video is created (i.e. a subtraction operation 310-S is applied to the down-sampled input video and the decoded base stream to generate a first set of residuals). Here the term residuals is used in the same manner as that known in the art; that is, residuals represent the error or differences between a reference signal or frame and a desired signal or frame. Here the reference signal or frame is the decoded base stream and the desired signal or frame is the down-sampled input video. Thus the residuals used in the first enhancement level can be considered as a correction signal as they are able to ‘correct’ a future decoded base stream to be the or a closer approximation of the down-sampled input video that was used in the base encoding operation. This is useful as this can correct for quirks or other peculiarities of the base codec. These include, amongst others, motion compensation algorithms applied by the base codec, quantization and entropy encoding applied by the base codec, and block adjustments applied by the base codec.

The components of block 300-1 in FIG. 3 are shown in more detail in FIG. 5. In particular, the first set of residuals are transformed, quantized and entropy encoded to produce the encoded level 1 stream. In FIG. 5, a transform operation 310-1 is applied to the first set of residuals; a quantization operation 320-1 is applied to the transformed set of residuals to generate a set of quantized residuals; and, an entropy encoding operation 330-1 is applied to the quantized set of residuals to generate the encoded level 1 stream at the first level of enhancement. However, it should be noted that in other examples only the quantization step 320-1 may be performed, or only the transform step 310-1. Entropy encoding may not be used, or may optionally be used in addition to one or both of the transform step 110-1 and quantization step 320-1. The entropy encoding operation can be any suitable type of entropy encoding, such as a Huffmann encoding operation or a run-length encoding (RLE) operation, or a combination of both a Huffmann encoding operation and a RLE operation. A residuals processing operation 350-2, 350-1 may be provided in certain embodiments prior to either transform operation 310-2, 310-1 or both. The residual processing operation 350 applies residual pre-processing as described herein, e.g. filtering the residuals received by the block so as to only pass a subset of the received residuals onto the transform operation 310 (or in other words to set certain residual values to zero such that the original values are not processed within the subsequent operations of the pipeline).

As noted above, the enhancement stream may comprise the encoded level 1 stream (the first level of enhancement) and the encoded level 2 stream (the second level of enhancement). The first level of enhancement may be considered to enable a corrected video at a base level, that is, for example to correct for encoder and/or decoder artefacts. The second level of enhancement may be considered to be a further level of enhancement that is usable to convert the corrected video to the original input video or a close approximation thereto (e.g. to add detail or sharpness). For example, the second level of enhancement may add fine detail that is lost during the downsampling and/or help correct from errors that are introduced by one or more of the transform operation 310-1 and the quantization operation 320-1.

Referring to FIG. 3 and FIG. 5, to generate the encoded level 2 stream, a further level of enhancement information is created by producing and encoding a further set of residuals at block 300-2. The further set of residuals are the difference between an up-sampled version (via up-sampler 305U) of a corrected version of the decoded base stream (the reference signal or frame), and the input signal 30 (the desired signal or frame).

To achieve a reconstruction of the corrected version of the decoded base stream as would be generated at the decoder 400, at least some of the processing steps of block 300-1 are reversed to mimic the processes of the decoder 200, and to account for at least some losses and quirks of the transform and quantization processes. To this end, block 300-1 comprises an inverse quantize block 320-1i and an inverse transform block 310-1i. The quantized first set of residuals are inversely quantized at inverse quantize block 320-1i and are inversely transformed at inverse transform block 310-1i in the encoder 100 to regenerate a decoder-side version of the first set of residuals.

The decoded base stream from decoder 320D is combined with this improved decoder-side version of the first set of residuals (i.e. a summing operation 310-C is performed on the decoded base stream and the decoder-side version of the first set of residuals). Summing operation 310-C generates a reconstruction of the down-sampled version of the input video as would be generated in all likelihood at the decoder—i.e. a reconstructed base codec video). As illustrated in FIG. 3 and FIG. 5, the reconstructed base codec video is then up-sampled by up-sampler 305U.

The up-sampled signal (i.e. reference signal or frame) is then compared to the input signal 30 (i.e. desired signal or frame) to create a second set of residuals (i.e. a difference operation 300-S is applied to the up-sampled re-created stream to generate a further set of residuals). The second set of residuals are then processed at block 300-2 to become the encoded level 2 stream (i.e. an encoding operation is then applied to the further or second set of residuals to generate the encoded further or second enhancement stream).

In particular, the second set of residuals are transformed (i.e. a transform operation 310-2 is performed on the further set of residuals to generate a further transformed set of residuals). The transformed residuals are then quantized and entropy encoded in the manner described above in relation to the first set of residuals (i.e. a quantization operation 320-2 is applied to the transformed set of residuals to generate a further set of quantized residuals; and, an entropy encoding operation 320-2 is applied to the quantized further set of residuals to generate the encoded level 2 stream containing the further level of enhancement information). However, only the quantization step 20-1 may be performed, or only the transform and quantization step. Entropy encoding may optionally be used in addition. Preferably, the entropy encoding operation may be a Huffmann encoding operation or a run-length encoding (RLE) operation, or both. Similar to block 300-1, the residual processing operation 350-2 acts to pre-process, i.e. filter, residuals prior to the encoding operations of this block.

Thus, as illustrated in FIGS. 3 and 5 and described above, the output of the encoding process is a base stream at a base level, and one or more enhancement streams at an enhancement level which preferably comprises a first level of enhancement and a further level of enhancement. As discussed with reference to previous examples, the operations of FIG. 5 may be applied in parallel to coding units or blocks of a colour component of a frame as there are no inter-block dependencies. The encoding of each colour component within a set of colour components may also be performed in parallel (e.g. such that the operations of FIG. 5 are duplicated according to (number of frames)*(number of colour components)*(number of coding units per frame)). It should also be noted that different colour components may have a different number of coding units per frame, e.g. a luma (e.g. Y) component may be processed at a higher resolution than a set of chroma (e.g. U or V) components as human vision may detect lightness changes more than colour changes.

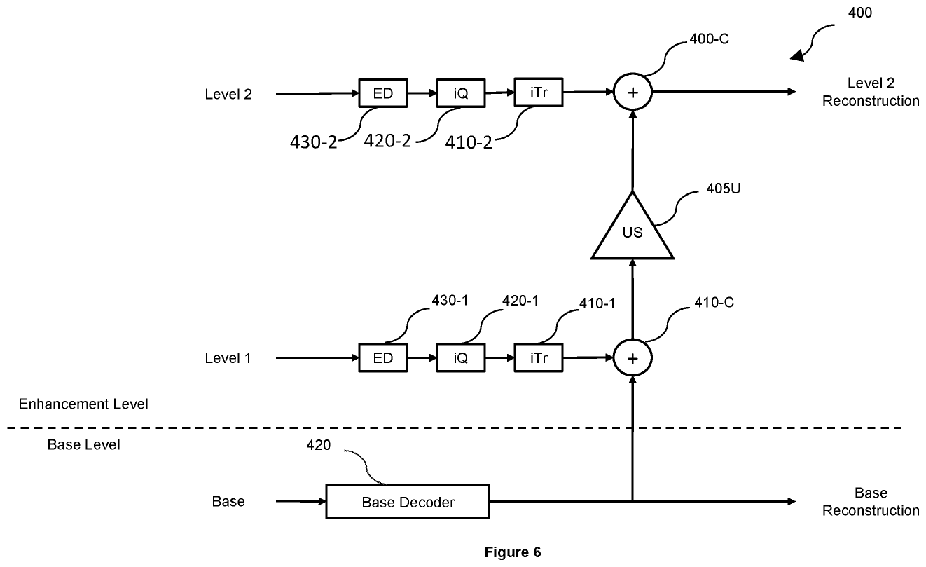

The encoded base stream and one or more enhancement streams are received at the decoder 400. FIG. 6 shows the decoder of FIG. 4 in more detail.

The encoded base stream is decoded at base decoder 420 in order to produce a base reconstruction of the input signal 30 received at encoder 300. This base reconstruction may be used in practice to provide a viewable rendition of the signal 30 at the lower quality level. However, the primary purpose of this base reconstruction signal is to provide a base for a higher quality rendition of the input signal 30. To this end, the decoded base stream is provided to processing block 400-1. Processing block 400-1 also receives encoded level 1 stream and reverses any encoding, quantization and transforming that has been applied by the encoder 300. Block 400-1 comprises an entropy decoding process 430-1, an inverse quantization process 420-1, and an inverse transform process 410-1. Optionally, only one or more of these steps may be performed depending on the operations carried out at corresponding block 300-1 at the encoder. By performing these corresponding steps, a decoded level 1 stream comprising the first set of residuals is made available at the decoder 400. The first set of residuals is combined with the decoded base stream from base decoder 420 (i.e. a summing operation 410-C is performed on a decoded base stream and the decoded first set of residuals to generate a reconstruction of the down-sampled version of the input video—i.e. the reconstructed base codec video). As illustrated in FIG. 4 and FIG. 6, the reconstructed base codec video is then up-sampled by up-sampler 405U.

Additionally, and optionally in parallel, the encoded level 2 stream is processed at block 400-2 of FIG. 2 in order to produce a decoded further set of residuals. Similarly to processing block 300-2, processing block 400-2 comprises an entropy decoding process 430-2, an inverse quantization process 420-2 and an inverse transform process 410-2. Of course, these operations will correspond to those performed at block 300-2 in encoder 300, and one or more of these steps may be omitted as necessary. Block 400-2 produces a decoded level 2 stream comprising the further set of residuals and these are summed at operation 400-C with the output from the up-sampler 405U in order to create a level 2 reconstruction of the input signal 30. The level 2 reconstruction may be viewed as an output decoded video such as 250 in FIG. 2. In certain examples, it may also be possible to obtain and view the reconstructed video that is passed to the upsampler 405U—this will have a first level of enhancement but may be at a lower resolution than the level 2 reconstruction.

Thus, as illustrated and described above, the output of the decoding process is an (optional) base reconstruction, and an original signal reconstruction at a higher level. This example is particularly well-suited to creating encoded and decoded video at different frame resolutions. For example, the input signal 30 may be an HD video signal comprising frames at 1920×1080 resolution. In certain cases, the base reconstruction and the level 2 reconstruction may both be used by a display device. For example, in cases of network traffic, the level 2 stream may be disrupted more than the level 1 and base streams (as it may contain up to 4× the amount of data where downsampling reduces the dimensionality in each direction by 2). In this case, when traffic occurs the display device may revert to displaying the base reconstruction while the level 2 stream is disrupted (e.g. while a level 2 reconstruction is unavailable), and then return to displaying the level 2 reconstruction when network conditions improve. A similar approach may be applied when a decoding device suffers from resource constraints, e.g. a set-top box performing a systems update may have an operation base decoder 220 to output the base reconstruction but may not have processing capacity to compute the level 2 reconstruction.

The encoding arrangement also enables video distributors to distribute video to a set of heterogeneous devices; those with just a base decoder 220 view the base reconstruction, whereas those with the enhancement level may view a higher-quality level 2 reconstruction. In comparative cases, two full video streams at separate resolutions were required to service both sets of devices. As the level 2 and level 1 enhancement streams encode residual data, the level 2 and level 1 enhancement streams may be more efficiently encoded, e.g. distributions of residual data typically have much of their mass around 0 (i.e. where there is no difference) and typically take on a small range of values about 0. This may be particularly the case following quantization. In contrast, full video streams at different resolutions will have different distributions with a non-zero mean or median that require a higher bit rate for transmission to the decoder.

As is seen by the examples of FIGS. 4 and 6, the residual modes may be applied at the encoder and the decoder may not require any additional residual processing. However, when residual processing is applied at the encoder, the level 1 and/or level 2 enhancement streams that are received at the decoder may differ from a comparative case wherein residual processing is not applied at the encoder. For example, when residual processing is applied, e.g. as per any of the examples described herein, the level 1 and/or level 2 enhancement streams will typically contain a greater number of 0 values that may be more efficiently compressed by the entropy encoding stages.

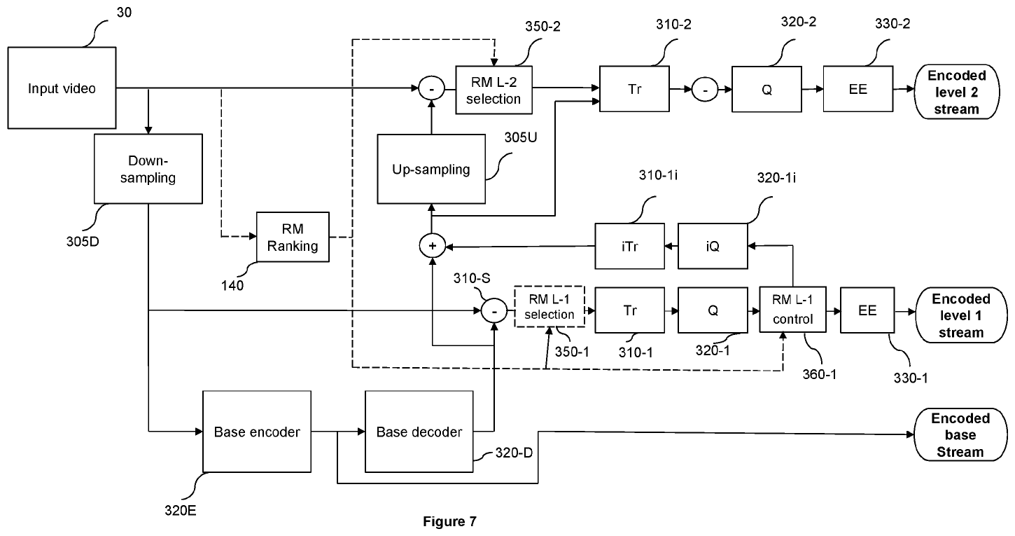

FIG. 7 illustrates an implementation example of the encoding process described above and illustrated. As is clearly identifiable, the encoding and decoding steps of the stream and expanded in detail.

In general, the steps include a residuals filtering mode step, a transform step, a quantization step and an entropy encoding step. The encoding process identifies if the residuals filtering mode is selected. The residual filtering mode may comprise a form of residual ranking. At a lowest level the ranking may be binary, e.g. residuals are ranked as either 0 or 1, if residuals are ranked at 0 they may not be selected for further processing; only residuals ranked 1 may be passed for further processing. In other cases, the ranking may be based on a greater number of levels. If residuals mode is selected the residuals filtering step may be performed (e.g. a residuals ranking operation may be performed on the first step of residuals to generate a ranked set of residuals). The ranked set of residuals may be filtered so that not all residuals are encoded into the first enhancement stream (or correction stream). In certain cases, the steps of ranking and filtering may be combined into a single step, i.e. some residual values are filtered out whereas other residuals values are passed for encoding.

In the example of FIG. 7, if a residual mode is applied such that residual values are processed prior to encoding within one or more enhancement levels, the result of the residual processing (e.g. a modified set of residuals) is then transformed, quantized and entropy encoded to produce the encoded level 1 or level 2 streams. If a residual mode is not selected, then residual values may be passed through the residual processing component for transformation, quantization and entropy encoding.

As noted above, generally it is preferred to ‘kill’ residuals rather than transformed coefficients. This is because processing the residuals at an early stage, e.g. by filtering the residuals based on a rank or other categorisation, means that values may be set to 0 to simplify the computations in the later more computationally expensive stages. Moreover, in certain cases, a residual mode may be set at a block or tile level. In this case, residual pro-processing (i.e. a residual mode) may be selected for all residual values corresponding to a particular coding unit or for a particular group of coding units. As there is no inter-block dependency, it does not matter if certain residual values are pre-processed whereas other residual values are not pre-processed. Being able to select a residual mode at a block or tile level enhances the flexibility of the proposed encoding scheme.

FIG. 7 illustrates a residual mode control block 360-1 that may be used to apply a residual mode at one or more later stages in an encoding pipeline. Here residual mode control is shown only in the L1 pathway but it may also be configured in the L2 pathway. The residual mode control block 360-1 is positioned preferably between the quantization 320-1 and entropy coding 330-1 blocks. In this case, residual values may be categorised, ranked and/or assigned a score at a residual mode selection block 350-1, yet the modification of the residual values may occur later than the residual mode selection block 350-1. Although not shown in the Figure, the residual mode control block 360-1 may control one or more of the transform operation 310-1 and the quantize operation 320-1. In one case, the residual mode selection block 350-1 may set control flags for residual elements (e.g. as described above) and these control flags may be used by the residual mode control block 360-1 to control one or more of the transform operation 310-1 and the quantize operation 320-1, or a further operation following the quantize operation 320-1. In one case, all residual values may be processed by the transform operation 310-1 and the quantize operation 320-1 yet filtered, weighted and/or set to zero via the residual mode control block 360-1. In another case, the quantize operation 320-1 may be configured to apply a coarser level of quantization based on a rank or priority of a residual (including binary ranks and priorities), such that the quantization operation 320-1 effectively sets a greater proportion of residual values to zero as compared to a case wherein a residual mode is not activated.

The residual mode control block 360-1 optionally also provides a degree of feedback and analyses the residuals after the effect of the processing to determine if the processing is having an appropriate effect or if it should be adjusted.

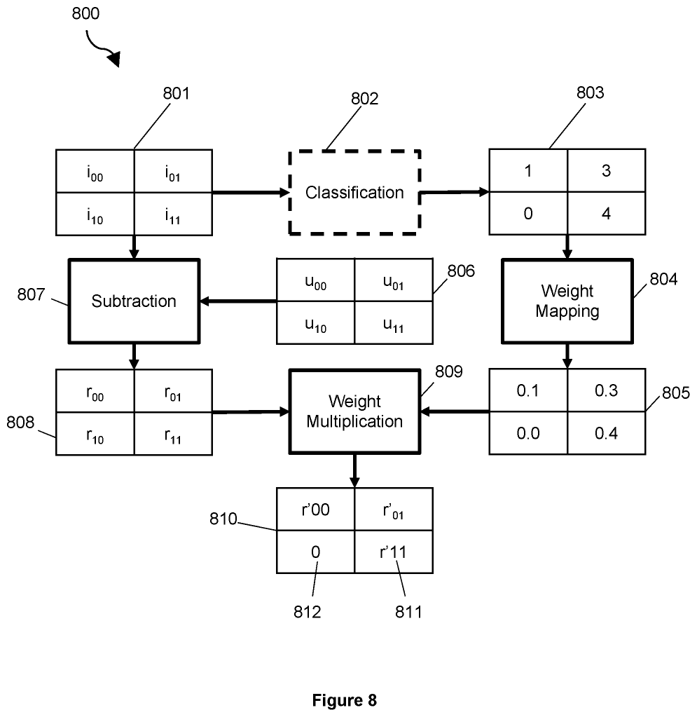

FIG. 8 shows an example 800 of a residual mode being applied. The example 800 relates to an example whereby classification (i.e. categorisation) and weighting is applied. Concepts described with reference to the present example may also be applied in part to other residual modes. This example relates to a L-2 stream but a similar set of components may be provided for a L-1 stream. The example is described with reference to a 2×2 coding unit but other coding units and/or pixel groupings may be used. A set of input image elements 801 (shown as pixel values iᵢⱼ—e.g. these may be a 16-bit or 8-bit integer representing a particular colour component, such as one of YUV or RGB, where i indicates an image row and j indicates an image column) are classified via a classification process 802 to generate a set of class indications 803 (e.g. in an integer range of 0 to 4 representing 5 classes). The class may indicate a level of contrast and/or texture. In other examples, the “class” may comprise a range for a metric, such as a contrast and/or texture metric for a grouping of pixels or residuals.

In FIG. 8, the class indications 803 are then used by a weight mapping component 804 to retrieve a set of weights 805 associated with the class indications 803. In this simple example, the weights are a set of values between 0 and 1. Each class may have an associated weight that may be retrieved from a look-up table. In other cases, each weight may be a function of a class or metric value (e.g. as an example the weights in FIG. 8 are 1/10^{th} of the class value but the relationship between class value and weight may be any relationship as set by a lookup table).

In parallel in FIG. 8, a set of reconstructed upsampled elements 806 (shown as elements uᵢⱼ) are subtracted, by a subtraction component 807, from the input image elements 801 to generate an initial set of residuals 808 (shown as elements rᵢⱼ). As is shown in the Figure, each coding unit or block of residual values may be associated with a corresponding coding unit or block of picture elements and/or reconstructed picture elements at a particular resolution (for level 1 residuals, a similar process may apply but the picture elements may correspond to downsampled pixels). The residuals 808 and the set of weights 805 are then input to a weight multiplication component 809 that multiplies the residuals 808 by the set of weights 805 to output a set of modified residuals 810 (shown as r′ᵢⱼ). As may be seen, a weight of 0 may act to set a subset of the residuals to 0 (see 812). As such in the example of FIG. 8, the original residual value r₁₀ is not passed on to further processing, instead it is set to 0. Residuals that have a non-zero weight applied (such as 811) are passed on for further processing but have been modified. In a simple case with binary weights (e.g. two classes), then a weight of 1 may indicate that the residual value is to be processed without modification. Non-zero weights may modify residuals in a manner that modifies how they are encoded. For example, the classification at block 802 may comprise an image classification, whereby residuals are modified based on the image classification of particular pixels. In another case, the classification at block 802 may comprise assigning the image values 801 to a particular grouping based on one or more of luma and contrast. In other examples, the classification at block 802 may select a single class and weight for the coding unit of four elements.

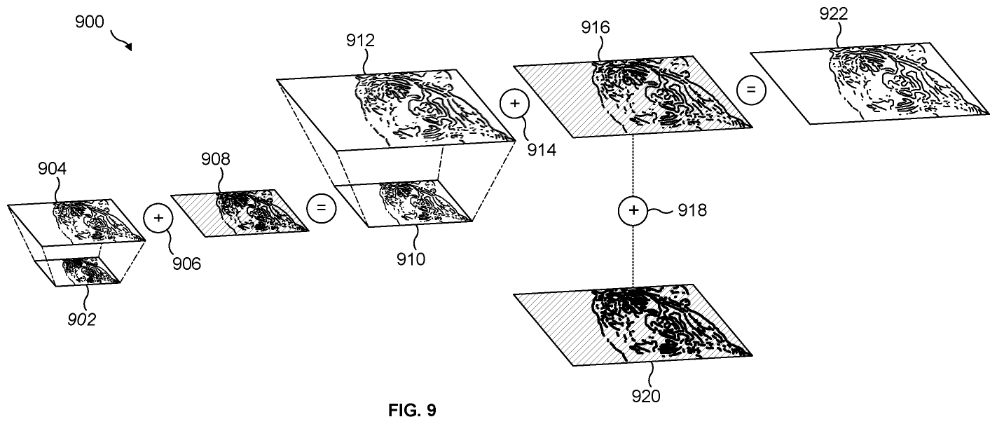

In certain cases, the characterization may be performed at a location remote from the encoder and communicated to the encoder. For example, a pre-recorded movie or television show may be processed once (e.g. by applying classification 802 and weight mapping 804) to determine a set of weights 805 for a set of residuals or group of residuals. These weights may be communicated over a network to the encoder, e.g. they may comprise the residual masks described with reference to FIGS. 9A to 9C, as will be described in more detail below. Alternatively, the classification 802, or both the classification 802 and the weight mapping 804, may instead be performed as part of the encoder parameter pre-processing described below.

In one case, instead of, or as well as weighting the residuals, the residuals may be compared against one or more thresholds derived from the categorization process. For example, the categorisation process may determine a set of classes that have an associated set of weights and thresholds, or just an associated set of thresholds. In this case, the residuals are compared with the determined thresholds and residuals that fall below a certain one or more thresholds are discarded and not encoded. For example, additional threshold processing may be applied to the modified residuals from FIG. 8 and/or the weight mapping 804 and weight multiplication 809 stages may be replaced with threshold mapping and threshold application stages. In general, in both cases for this example, residuals are modified for further processing based on a categorisation process, where the categorisation process may be applied to corresponding image elements.

Note that illustrated in FIG. 8, for one particular implementation, a local classification step may be optional (e.g. as indicated by the dotted line). In this case, one or more of the class indications 803 and the set of weights 805 may be obtained by a local process (e.g. from a remote location and/or from a stored file, and may be obtained from an encoder parameter pre-processing technique described below).

The above described methods of residual mode processing may be applied at the encoder but not applied at the decoder. This thus represents a form of asymmetrical encoding that may take into account increased resources at the encoder to improve communication. For example, residuals may be weighted to reduce a size of data transmitted between the encoder and decoder, allowing increases of quality for constrained bit rates (e.g. where the residuals that are discarded have a reduced detectability at the decoder). Residual weighting may have a complex effect on transformation and quantization. Hence, residual weights may be applied so as to control the transformation and quantization operations, e.g. to optimise a bit-stream given a particular available bandwidth.

In addition to the above described encoding and decoding technologies, in certain examples described herein, information from two of more frames of video that relate to different time samples may be used, as described in WO 2020/188273.

This may be described as a temporal mode, e.g. as it relates to information from different times. Not all embodiments may make use of temporal aspects.

A step of encoding one or more sets of residuals may utilise a temporal buffer that is arranged to store information relating to a previous frame of video. In one case, a step of encoding a set of residuals may comprise deriving a set of temporal coefficients from the temporal buffer and using the retrieved set of temporal coefficients to modify a current set of coefficients. “Coefficients”, in these examples, may comprise transformed residuals, e.g. as defined with reference to one or more coding units of a frame of a video stream-approaches may be applied to both residuals and coefficients. In certain cases, the modifying may comprise subtracting the set of temporal coefficients from the current set of coefficients. This approach may be applied to multiple sets of coefficients, e.g. those relating to a level 1 stream and those relating to a level 2 stream. The modification of a current set of coefficients may be performed selectively, e.g. with reference to a coding unit within a frame of video data.

Referring to FIG. 5, temporal prediction may be applied between the transformation 310-1, 310-2 and quantization 320-1, 320-2 steps of encoding the level 1 and/or level 2 stream. Referring to FIG. 6, temporal prediction may be applied after the inverse transformation 410-1, 410-2 steps of decoding the level 1 and/or level 2 stream.

In certain examples, there may be at least two temporal modes.
A first temporal mode that does not use the temporal buffer or that uses the temporal buffer with all zero values. The first temporal mode may be seen as an intra-frame mode as it only uses information from within a current frame. In the first temporal mode, following any applied ranking and transformation, coefficients may be quantized without modification based on information from one or more previous frames.
A second temporal mode that makes use of the temporal buffer, e.g. that uses a temporal buffer with possible non-zero values. The second temporal mode may be seen as an inter-frame mode as it uses information from outside a current frame, e.g. from multiple frames. In the second temporal mode, following any applied residual prioritization and transformation, previous frame dequantized coefficients may be subtracted from the coefficients to be quantized.

Temporal processing may be selectively applied at the encoder and/or the decoder based on an indicated temporal mode. A temporal mode may be signalled for one or more of the two enhancement streams (e.g. at level 2 and/or at level 1). The temporal mode may be signalled independently for each level of enhancement. Each level of enhancement may use a different temporal buffer.

Additionally, a temporal refresh parameter may signal when a temporal buffer is to be refreshed, e.g. where a first set of values stored in the temporal buffer are to be replaced with a second set of values. Temporal refresh may be applied at one or more of the encoder and the decoder. For example, in the encoder, a temporal buffer may store dequantized coefficients for a previous frame that are loaded when a temporal refresh flag is set (e.g. is equal to 1 indicating “refresh”). In this case, the dequantized coefficients are stored in the temporal buffer and used for temporal prediction for future frames (e.g. for subtraction) while the temporal refresh flag for a frame is unset (e.g. is equal to 0 indicating “no refresh”). In this case, when a frame is received that has an associated temporal refresh flag set to 1, the contents of the temporal buffer are replaced. This may be performed on a per frame basis and/or applied for portions of a frame such as tiles or coding units.

FIG. 9 shows a graphical representation 900 of the decoding process described in certain examples herein, making use of a temporal buffer. The various stages in the decoding process are shown from left to right in FIG. 9. The example of FIG. 9 shows how an additional up-sampling operation may be applied following the decoding of the base picture.

At the far left of FIG. 9, a decoded base picture 902 is shown. This may comprise the output of the base decoder as described in examples herein. In the present example, a selectable up-sampling (i.e. up-scaling) is performed on a lower resolution decoded base picture 902. The lower resolution decoded base picture 902 may be considered as a level 0 or layer 0 signal. Up-sampling of a decoded base picture may be applied based on a signalled scaling factor.

FIG. 9 shows a first up-sampling operation to generate a preliminary intermediate picture 904. This may be considered to be at a spatial resolution associated with the level 1 enhancement (e.g. a level 1 signal). In FIG. 9, the preliminary intermediate picture 904 is added 906 to a first layer of decoded residuals 908 (e.g. as resulting from enhancement level 1) to generate a combined intermediate picture 910. The combined intermediate picture 910 may then be up-sampled during a second upsampling operation to generate a preliminary output picture 912. The second up-sampling operation may be selectively applied (e.g. may be omitted or only performed in one dimension rather than two) depending on a signalled scaling factor. The preliminary output picture 912 may be considered to be at a level 2 spatial resolution.

At stage 914, the preliminary output picture 912 is added to a second layer of decoded residuals 916 (e.g. as resulting from enhancement level 2). The second layer of decoded residuals 916 are shown with an added 918 contribution from information stored in a temporal buffer 920. The information 920 may reduce the amount of information needed to reconstruct the second layer of residuals 916. This may be of benefit as there is more data at the second level (level 2) due to the increased spatial resolution (e.g. as compared to the first level-level 1-resolution). In FIG. 9, the output of the last addition is a final combined output picture 922. This may be viewed as a monochrome video, and/or the process may be repeated for a plurality of colour components or planes to generate a colour video output.

Further to the above described encoding and decoding techniques, in certain implementations, one or more parameters of the quantization operation may be controlled to control a bit rate of one or more of the encoded streams, as described in WO 2020/188273. Furthermore, different encoded streams (e.g. the encoded level 1 stream, and the encoded level 2 stream) may each be controlled to have a different bit rate.

In certain cases, the quantization parameters may be set based on an analysis of one or more of the base encoding and the enhancement stream encoding.

Quantization parameters may be chosen to provide a desired quality level, or to maximise a quality level within a set of pre-defined bit-rate constraints. For example, an encoder may comprise an output buffer configured to receive bits at variable bit rates and to output bits at a constant rate. Quantization parameter(s) may be controlled by reading the status of the buffer and ensuring that the buffer does not overflow or become empty, such that data are always available to be read at its output.

Such an output buffer may be arranged at an output of the encoded level 1 stream, the encoded level 2 stream or a combination of streams. Furthermore, each stream may have an individual buffer for output rate control.

In one case, the quantization parameters values are inversely related to the amount of data in the buffer. For example, in order to reduce the amount of residual data that is encoded, low values of a quantization parameter may correspond to larger quantization step-width values that result in fewer quantization bins for a given range of residual values. Conversely, high values of the quantization parameter may correspond to smaller quantization step-width values which increase the amount of encoded residual data but may also increase the fidelity of the decoded video.

Quantization parameters may in some cases include:
a dead zone parameter such that residuals having a value in a certain range are set to zero (and effectively discarded),
a bin folding parameter such that residuals having a greater than maximum value are set to the maximum value,
a quantization offset parameter (typically used with a dead zone parameter) such that the quantized residual values associated with quantization bins are offset from the corresponding residual value input for quantization. This can reduce the number of bits required to represent a quantized residual value, and/or
a quantization matrix parameter. After transformation, the residual for a 2×2 or 4×4 coding unit may include coefficients such as a horizontal, vertical and diagonal directional decomposition. These may more heavily influence perception of a decoded signal than other values in a transformed residual. Accordingly, these more influential values may be quantized with smaller quantization bins, and less influential values may be quantized with larger quantization bins. The different quantization parameters for different values may be provided as a quantization matrix parameter.

Additionally, a bit rate controller of an encoder may be configured to identify “filler” bits of the encoded base stream and to discard or replace such “filler”.

Having described various implementations of an encoder and decoder, the following description provides examples of a pre-analysis module which can be used with an encoder, such as an encoder as described above. Furthermore, the pre-analysis module may generate header data which can be incorporated as a stream with encoded data generated by the encoder, wherein the header data is configured to be used by a corresponding decoder.

The encoder may receive one or more of encoder parameters and residual masks. Encoder parameters may comprise values for one or more parameters that control the encoder 1000. In one case, encoder parameters may include parameters for one or more of the base encoder, the processing components for the level 1 stream and the processing components for the level 2 stream. The encoder parameters or the residual masks may be applied at a per-residual or per-residual-group (e.g. coding unit or block) level, or a per-frame level or per-frame-group level. The encoder parameters may be used to configure one or more of a stream resolution, quantization, sequence processing, temporal prediction, bitrates and codec for each stream. Residual masks may comprise a weighting, e.g. from 0 to 1, to apply to sets of residuals, e.g. to apply to 2×2 or 4×4 groupings (i.e. blocks) of residuals. The residual masks may be similar to one of the class indications 803 and the set of weights 805 in FIG. 8. A residual mask may be supplied as a surface for each frame of video (whereby there may multiple surfaces for different colour components). If the mask is applied at the group level, any received surface may be at a reduce resolution (e.g. for a 2×2 coding block the mask may comprise a video at half-resolution containing residual weight values). The residual masks may indicate a priority for delivery of the blocks to the decoder and/or for encoding.

In another case, the residual masks may comprise a weighting that control processing of the blocks, e.g. certain blocks may be visually enhanced or weighted. Weighting may be set based on a class (e.g. a label or numeric value) applied to one or more blocks of residuals. In certain cases, the residual masks may be binary masks (e.g. binary bitmaps) indicating whether to encode the residual values.

In certain cases, the encoder may be adapted to perform encodings at a plurality of bitrates. In this case, the encoder parameters may be supplied for each of the plurality of bitrates. In certain cases, configuration data may be provided as one or more of global configuration data, per frame data and per block data. In examples, residual masks and temporal signalling may be provided on a per frame basis. For example, the plurality of bitrates may be set based on an available capacity of a communications channel, e.g. a measured bandwidth, and/or a desired use, e.g. use 2 Mbps of a 10 Mbps downlink channel.

Additionally, the encoder may feedback data to the pre-analysis module. The data may include one or more of a base codec type, a set of required bitrates and sequence information. The base codec type may indicate a type of base encoder that is used for a current set of processing. In certain cases, different base encoders may be available. In one case, the base encoder may be selected based on a received base codec type parameter; in another case, a base codec type may be selected based on local processing within the encoder. The set of bitrates that are required may indicate one or more bitrates that are to be used to encode one or more of the base stream and the two enhancement streams. Different streams may use different (or respective) bit rates. The enhancement streams may use additional bandwidth if available; e.g. if bandwidth is not available then bandwidth may be used by the encoded base and level 1 streams to provide a first level of quality at a given bitrate; the encoded level 2 stream may then use a second bit rate to provide further improvements. This approach may also be applied differentially to the base and level 2 streams in place of the base and level 1 streams. The residual processing described herein may be used together with bit rate parameters to control a bit rate of one or more of the enhancement streams.

In one case, the encoder parameters received may indicate one or more of residual modes to be applied by the encoder. Again, a residual mode may be set at a per frame, per tile, and/or per block or coding unit level. The encoder parameters may indicate modes for each stream separately or indicate a common mode for both enhancement streams. The residual mode parameters may be received by the residual mode selection components described herein. In certain cases, the residual mode selection components may be omitted and the residual mode parameters may be received by other components of the encoder directly, e.g. the components of examples herein may receive the residual mode parameters from a cloud interface of the encoder. In certain cases, each residual mode may be indicated by an integer value. The residual mode may indicate what form of residual (pre-) processing is to be applied.

The pre-analysis module may be local to the encoder and may be configured to operate at the same time as the encoder. For example, the pre-analysis module and the encoder may be separate software or hardware modules of a single device. Alternatively, the pre-analysis module may be configured to operate asynchronously from the encoder.

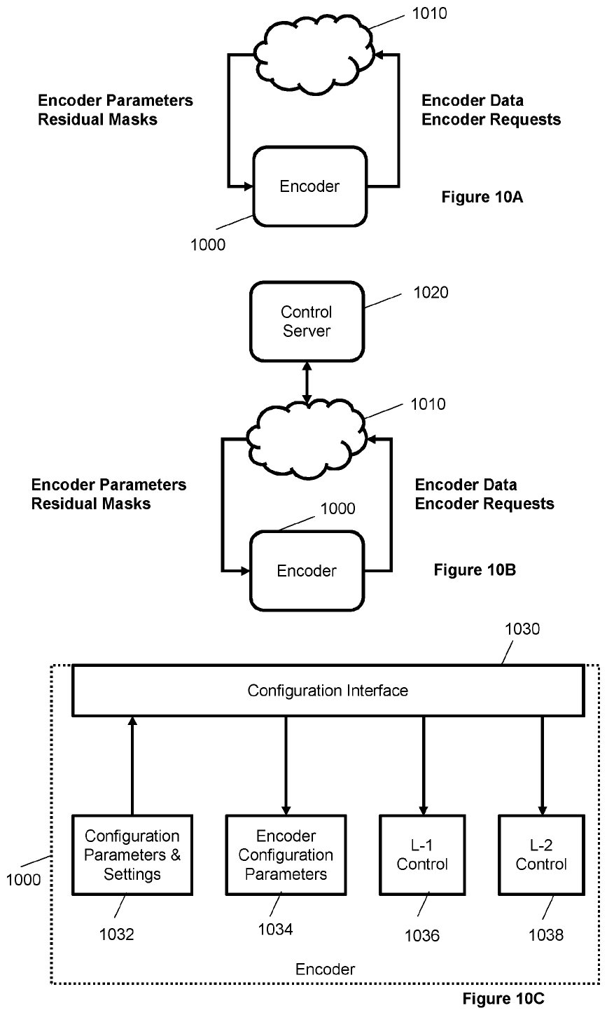

In some embodiments, as shown in FIG. 10A, the pre-analysis module may be a remote device configured to communicate with the encoder 1000 (or encoding process). FIG. 10A shows an encoder 1000 communicating across a network 1010 (represented by a cloud in the Figure). The encoder may comprise an implementation of any of the encoders from the previous Figures. In one case, the encoder 1000 may receive configuration data across the network 1010 and/or transmit configuration data across the network 1010.

In one case, the encoder 1000 may have different configuration settings relating to a remote or cloud configuration. In one mode, which may be a “default” mode, the encoder 1000 may be configured to make a remote program call across the network to retrieve initial configuration parameters to perform encoding as described herein. In another mode, which may be a “custom” mode, the encoder 1000 may retrieve local parameter values that indicate a particular user configuration, e.g. a particular set of tools that are used by the encoder 1000 and/or configurations for those tools. In one case, the encoder 1000 may have different modes which indicate which parameters are to be retrieved from a remote device and which parameters are to be retrieved from local storage.

FIG. 10B shows that the encoder 1000 may send and/or receive configuration data to and/or from a remote control server 1020 over the network 1010. The control server 1020 may comprise a server computing device that implements a pre-analysis module and an application programming interface for receiving or sending data. For example, the control server 1020 may implement a RESTful interface, whereby data may be communicated by (secure) HyperText Transfer Protocol (HTTP) requests and responses. In another case, a side channel implemented using a specific communication protocol (e.g. at the transport or application layer) may be used for communications between the control server 1020 and the encoder 1000 over the network 1010. The network 1010 may comprise one or more wired and/or wireless networks, including local and wide area networks. In one case, the network 1010 may comprise the Internet.

FIG. 10C shows how an encoder 1000 may comprise a configuration interface 1030 that is configured to communicate over the network 1010, e.g. with the remote control server 1020. The configuration interface 1030 may comprise a hardware interface, e.g. an Ethernet and/or wireless adapter, and/or software to provide a communications stack to communicate over one or more communications networks. In FIG. 10C, configuration parameters and settings 1032 that are used and/or stored by the encoder 1000 are communicated over the network using the configuration interface 1030. Encoder configuration parameters, e.g. that may be stored in one or more memories or registers, are received 1034 from the configuration interface. In one case, the encoder configuration parameters may control one or more of downsampling, base encoder and base decoder components within the encoder, e.g. as shown in the Figures The configuration interface also communicates L-1 control data 1036 and L-2 control data 1038 data to each of an L-1 and an L-2 stream control component. These components may configure tool use on each enhancement stream. In one case, the L-1 and an L-2 stream control components control one or more of residual mode selection, transform, quantize, residual mode control, and entropy encoding components (e.g. as shown in the Figures and described herein).

Using a cloud configuration as described herein may provide implementation advantages. For example, an encoder 1000 may be controlled remotely, e.g. based on network control systems and measurements. An encoder 1000 may also be upgraded to provide new functionality by upgrading firmware that provides the enhancement processing, with additional data, e.g. based on measurements or pre-processing being supplied by one or more remote data sources or control servers. This provides a flexible way to upgrade and control legacy hardware devices.

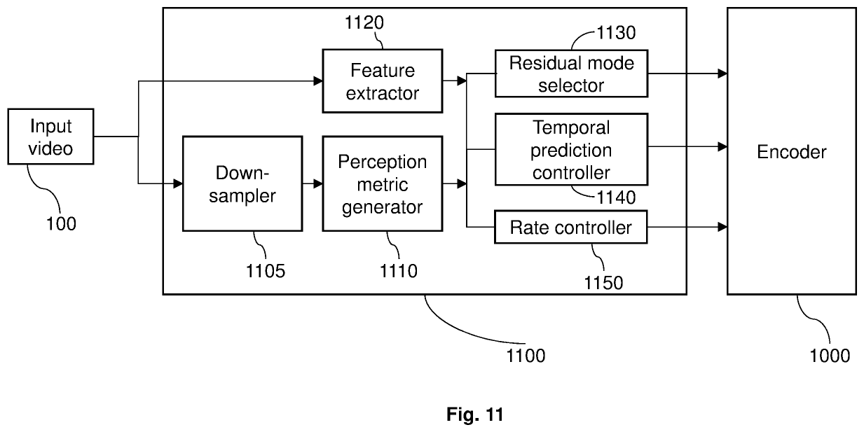

FIG. 11 schematically illustrates a pre-analysis module 1100 that is configured to determine one or more encoder parameters, and which may be implemented as computer software or hardware.

The pre-analysis module 1100 is configured to receive an input video 100 which may be the same input video 100 received later by an encoder 1000 as part of an encoding procedure, such as the encoding procedures shown in FIGS. 1, 3, 5 and 7.

The pre-analysis module 1100 outputs the encoder parameter to an encoder 1000, which uses the encoder parameter as described above. For example, the pre-analysis module 1100 may be located in a control server 1020 as shown in FIG. 10B, and may communicate with the encoder 1000 via an interface 1030 as shown in FIG. 10C.

The pre-analysis module 1100 comprises a perception metric generator 1110. As a first stage of pre-analysis, the perception metric generator 1110 generates a detail perception metric based on one or more frames of the input video 100.

The detail perception metric is a metric for how noticeable the details shown in the one or more frames are expected to be, and/or how noticeable changes in those details are expected to be. The detail perception metric may be generated for individual coding units or blocks of a frame, or for a whole frame. Additionally, the detail perception metric may be generated for different planes of data, such as different colour components of a video signal. Additionally or alternatively, the detail perception metric may be calculating by comparing two or more frames.

In some examples, the detail perception metric may comprise an edge detection metric. A user may be more likely to notice loss of detail in the edge of an object depicted in a frame, when compared to loss of detail in the bulk of the object.

The edge detection metric may be implemented using a transform. The transform may be similar to the method using for transforming residuals in elements 310-1 and 310-2 of FIG. 3, but applied to frames (or coding units or blocks thereof). The transform as described herein may use a directional decomposition transform such as a Hadamard-based transform. The transform may comprise a small kernel or matrix that is applied to flattened coding units of the frame (i.e. 2×2 or 4×4 blocks of pixels). The pre-analysis module may select between different transforms to be used, for example between a size of kernel to be applied.

The transform may transform the pixel information to surfaces. For example, the transform may produce the following components: vertical tilt (“V”, corresponding to the vertical difference of the pixels, as the sum of the pixels on top minus sum of the pixels on the bottom), horizontal tilt (“H”, corresponding to the horizontal difference of the pixels, as the sum of the pixels on the left minus the sum of the pixels on the right) and diagonal tilt (“D”, corresponding to the remaining differences, not explained by a simple directional transition in the blocks of pixels). For reference, an example of directional decomposition is shown in PCT/EP2013/059847 FIGS. 3A and 3B.

The edge detection metric may alternatively comprise a binary choice, or a selection from a discrete set of options, such as: no edges, few edges, many edges. Such a selection may be based on comparing one or more elements of the directional decomposition transform to one or more respective thresholds. The thresholds may in turn depend on high-level parameters for encoding, such as a required bit rate. For example, when a low bitrate is required, the threshold for determining that there are edges may be relatively high, so that most of the input video is encoded more compactly.

Furthermore, the edge detection metric may comprise a text detection metric. Text features are commonly defined by edges, and the user is particularly likely to notice loss of detail in text depicted in a frame.

In some examples, the detail perception metric may comprise a motion metric based on comparing two or more frames. A user may be more likely to notice loss of detail in directional motion, when compared to loss of detail in other types of motion. Furthermore, when a frame or portion of a frame is static, it may be easier for viewers to spot tiny details, and therefore it may be important to preserve residual information, e.g. a priority of certain static residual elements may be higher than a comparative set of transient residual elements. Also sources of noise in an original video recording at higher resolutions (e.g. an L-2 enhancement stream) may lead to many small yet transient residual values (e.g. normally distributed values of −2 or −1 or 1 or 2)—these may be given a lower priority and/or set to 0 prior to residual processing in the enhancement level encoders.

The motion metric may comprise a sum of absolute differences (SAD) between a pair of frames. The motion metric may be evaluated in this manner per frame pair, per block pair or per coding unit pair.

For example, a motion metric for motion between a frame m and a frame n may be based on Jₒ=Sum(abs(I_{x,y,n}−I_{x,y,m})), where I_{x,y,n} is a value for coding unit (x,y) of frame n, and I_{x,y,m} is a value for coding unit (x,y) of frame m.

Furthermore, when the motion metric is based on comparing more than two frames, the motion metric may comprise a weighted sum of SAD values. For example, a detail perception metric for a frame n may be calculated by comparing frame n to each of preceding frames k and m, and the motion metric may be based on:

$${J}_{0} = Sum ( abs ( {I}_{x , y , n} - {I}_{x , y , m} ) ) + Sum ( abs ( {I}_{x , y , n} - {I}_{x , y , k} ) ) , or$$

$${J}_{0} = {w}_{m} \cdot Sum ( abs ( {I}_{x , y , n} - {I}_{x , y , m} ) ) + {w}_{k} \cdot Sum ( abs ( {I}_{x , y , n} - {I}_{x , y , k} ) ) ,$$

where wₘ and wₖ are weighting factors.

The motion metric may alternatively comprise a binary choice, or a selection from a discrete set of options, such as: no motion, low motion, high motion. Such a selection may be based on comparing the sum of absolute differences to one or more thresholds. The thresholds may in turn depend on high-level parameters for encoding, such as a required bit rate. For example, when a low bitrate is required, the threshold for determining that there is motion may be relatively high, so that most of the input video is encoded more compactly.

The first frame and second frame used to generate the motion metric may be consecutive frames of the input video 100, or the motion metric may be generated at a reduced frequency (e.g. comparing motion between two frames separated by N>1 intermediate frames of the input video, comparing motion between randomly sampled frames of the input video, etc.) depending on contextual requirements. The frequency of generating the motion metric may depend upon the motion metric (for example, decreasing motion metric generation frequency after generating the detail perception metric for a series of frames exhibiting low motion).

The number of times the motion metric is calculated may be reduced by reusing the same calculation for forward and backward motion. In other words, when a motion metric is calculated by comparing frames m and n, this motion metric may be used when generating a detail perception metric for frame m and when generating a detail perception metric for frame n. For example, adjacent frames may be paired up, with the motion metric calculated once for each pair of frames (i.e. a motion metric is calculated for frames 1 and 2, for frames 3 and 4, for frames 5 and 6, etc.).

The detail perception metric may comprise a combination of metrics. For example, the detail perception metric may comprise an edge detection metric based on a second frame and a motion metric based on a difference between first and second frames.

Referring again to FIG. 11, the pre-analysis module 1100 further comprises a down-sampler 1105 configured to down-sample frames of the input video 100 before they are received by the perception metric generator 1110. The down-sampler 1105 may, for example, be similar to the downsampling component 105 of FIG. 1. As a result, the detail perception metric is generated based on one or more down-sampled video frames. This down-sampling reduces the processing resources required to generate the detail perception metric and determine an encoder parameter but, as the inventors have found, can have minimal impact on the perceived quality of video that has been encoded and decoded according to encoder parameters determined in this way.

Where the pre-analysis module 1100 is used with an encoder as shown in FIG. 1, the down-sampler 1105 may be configured to down-sample frames to the same resolution as downsampling component 105. This has the advantage that the encoder performs level 1 encoding at the same resolution at which the pre-analysis module determined the encoder parameter(s). Alternatively, the down-sampler 1105 may be configured independently from the encoder 1000.

Referring again to FIG. 11, the pre-analysis module 1100 may further comprise a feature extractor 1120. As part of the first stage of pre-analysis, the feature extractor 1120 may extract additional metrics and statistics for use in determining one or more encoder parameters. The extracted features may comprise, for each block or coding unit of a frame: a histogram; a mean value; a minimum value; a maximum value. Based on the extracted features, the feature extractor may classify each block or coding unit within the frame, for example by providing a perceptibility rating relative to adjacent blocks or coding units. In some 30 embodiments, the feature extractor 1120 may be omitted.

In some embodiments, the pre-analysis module 1100 comprises at least one encoder parameter determining unit. As a second stage of pre-analysis, the encoder parameter determining unit determines an encoder parameter based on the detail perception metric. The encoder parameter determining unit may in some embodiments also use the features extracted by the feature extractor 1120 together with the detail perception metric to determine the encoder parameter. The encoder parameter may be determined for each frame, for each group of one or more frames, or for a portion (e.g. a tile, a block or a coding unit) of one or more frames. In some embodiments the encoder parameter determining unit is omitted, and the detail perception metric itself is used as an encoder parameter which may be provided to the encoder 1000.

In many embodiments, the encoder parameter is indicative of a priority level associated with the frame, block or coding unit for which the detail perception metric was calculated. A higher-priority means allocation of greater resources at the encoder (e.g. more bits in the encoded bitstream to enable decoding of the video with lower loss, or more time-consuming processing at the encoder). On the other hand, a lower-priority means allocating lower resources at the encoder (e.g. accepting more lossy compression, or more truncated processing at the encoder).

In one specific example, the pre-analysis module comprises a residual mode selector 1130 as an implementation of the encoder parameter determining unit. This type of encoder parameter is particularly suited to pre-analysis for an LCEVC encoder. Examples of residual modes and their applications are discussed above with respect to the residual mode selection block 140 of FIG. 1.

The residual mode may be determined by categorizing a frame, block or coding unit which is to be encoded. The categorisation may be based, for example, on certain spatial and/or temporal characteristics of the input image, such as the detail perception metric and optionally also the features extracted by the feature extractor 1120. For example, the residual mode may be chosen by comparing the detail perception metric against one or more thresholds.

In another specific example, the pre-analysis module comprises a temporal prediction controller 1140, as an implementation of the encoder parameter determining unit. The temporal prediction controller is configured to determine whether or not to apply temporal prediction. This type of encoder parameter is again particularly suited to pre-analysis for an LCEVC encoder. Temporal prediction is explained above with respect to FIGS. 5 and 9. In some embodiments, the temporal prediction controller 1140 may be omitted.

The detail perception metric may be used to estimate a cost of temporal prediction, on a per frame basis and/or on a per portion basis, e.g. per tile and/or per coding unit. The cost of temporal prediction increases if it is expected to cause a loss of perceived quality. On the other hand, the cost of temporal prediction decreases based on the expected improvement of compression in frames encoded using temporal prediction of residuals.

In one case, a cost that is used to determine whether or not to apply temporal prediction may be controllable, e.g. by setting a parameter in a configuration file. The cost may be evaluated with and without temporal prediction, and temporal prediction may be used when it has lower cost than not using temporal prediction.

In certain cases, the encoding parameter may comprise a map that indicates whether or not to apply temporal prediction for a frame, or a set of portions of a frame, of video.

In one example, the cost function may be simply the motion metric generated by the perception metric generator 1110.

The temporal prediction controller 1140 may further be configured to control whether or not to perform a temporal refresh for a frame.

In another specific example, the pre-analysis module comprises a rate controller 1150. The rate controller is configured to manage encoding to achieve a required bit rate, as described above with reference to the output buffer feature present in some encoders.

For example, the rate controller may be configured to determine one or more quantization parameters. The determined quantization parameters may include any of a quantization bin size, a dead zone parameter, a bin folding parameter, a quantization offset parameter and a quantization matrix parameter.

The rate controller may be configured to determine an encoding parameter based on the detail perception metric generated by the perception metric generator 1110 and optionally also the features extracted by the feature extractor 1120. As one example, a detail perception metric may indicate high perception of details in a specific portion (e.g. tile or block) of one or more frames. This may be due to, for example, edges or motion. At the same time, a feature extracted by the feature extractor 1120 may indicate that the pixel values in the specific portion fall within a small part of the total possible value range. In response, a quantization bin size parameter may be decreased and the size of a dead zone may be increased. This may have the effect of increasing the level of detail without increasing the required number of bits for residuals.

In cases where multiple encoder parameters are determined, then the determination for one parameter may be used as an input for the determination of another parameter.

For example, if a quantization parameter determined for a frame, block or coding unit would cause at least one corresponding residual at the encoder to not be quantized or quantized to zero, then the residual mode can be determined to prevent transformation or quantization of that residual at the encoder. This avoids unnecessarily performing transformation on the residual at the encoder, and thereby saves encoder processing resources.

The encoder parameter determining unit(s) 1130, 1140, 1150 may be configured to pass encoder parameters to the encoder 1000 in real time. Alternatively, the pre-analysis module 1100 may store the determined encoder parameters for subsequent use in an encoder 1000.

In other embodiments, the pre-analysis module 1100 may simply generate the detail perception metric using the perception metric generator 1110, and pass the detail perception metric to the encoder 1000. The encoder parameter determining units may instead be arranged as part of the encoder 1000.

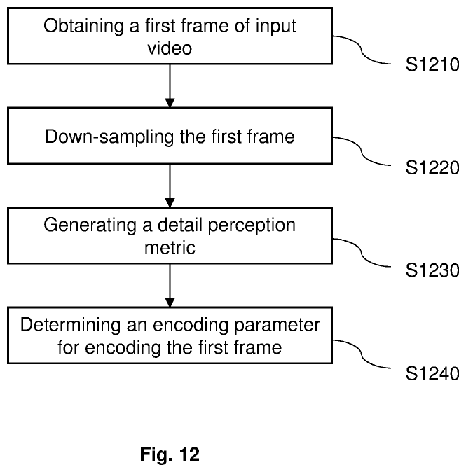

FIG. 12 schematically illustrates a method which may be performed by the pre-analysis module in one embodiment.

Referring to FIG. 12, at step S1210, the pre-analysis module obtains a first video frame of the input video 100. The first frame be any frame which is expected to be subsequently encoded by an encoder 1000, and “first” is not indicative of any particular position in the sequence of frames of the input video.

At step S1220, the pre-analysis module down-samples the first video frame to obtain a first down-sampled video frame. This may be implemented using the down-sampler 1105 as described above.

At step S1230, the pre-analysis module generates a detail perception metric based on the first down-sampled video frame. This may be implemented using the perception metric generator 1110 as described above.

At step S1240, the pre-analysis module determines, based on the detail perception metric, an encoder parameter for encoding the first video frame. This step may be implemented using an encoder parameter determining unit as described above, such as a residual mode selector 1130, a temporal prediction controller 1140 or a rate controller 1150.

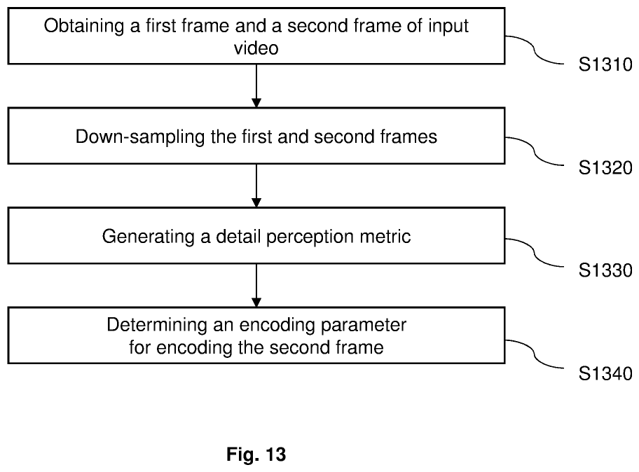

FIG. 13 schematically illustrates a method which may be performed by the pre-analysis module in another embodiment.

Referring to FIG. 13, at step S1310, the pre-analysis module obtains two video frames of the input video 100 (a first video frame and a second video frame). The first and second video frames be any two different frames which are expected to be subsequently encoded by an encoder 1000, and “first” and “second” are not indicative of any particular position in the sequence of frames of the input video, although the second video frame follows (i.e. occurs at least one frame after) the first video frame in the sequence of video frames. As examples, the second frame may be one frame after the first frame (i.e. the immediately following frame), or two frames after the first frame, in the sequence of frames of the input video 100.

At step S1320, the pre-analysis module down-samples the first and second video frames to obtain first and second down-sampled video frames. This may be implemented using the down-sampler 1105 as described above.

At step S1330, the pre-analysis module generates a detail perception metric based on the first and second down-sampled video frames. This may be implemented using the perception metric generator 1110 as described above.

At step S1340, the pre-analysis module determines, based on the detail perception metric, an encoder parameter for encoding the second video frame. This step may be implemented using an encoder parameter determining unit as described above, such as a residual mode selector 1130, a temporal prediction controller 1140 or a rate controller 1150.

The method of FIG. 13 differs from the method of FIG. 12 in that multiple frames are used to determine the detail perception metric at step S1330, and therefore the detail perception metric can include a motion metric.

1-16. (canceled)

17. A method for determining an encoder parameter for encoding an input video comprising a sequence of video frames, the input video having a first resolution, the method comprising:
obtaining a first and a second video frame of the input video, wherein the second video frame follows the first video frame in the sequence of video frames;
down-sampling the first and second frames to a second resolution to obtain a first and a second down-sampled video frame;
generating a detail perception metric based on the first and second down-sampled video frames; and
determining, based on the detail perception metric, an encoder parameter for encoding the second video frame,
wherein the detail perception metric comprises an edge detection metric based on the second down-sampled frame and a motion metric based on a difference between the first and second down-sampled frames.

18. The method according to claim 17, wherein the edge detection metric comprises a text detection metric.

19. The method according to claim 17, wherein the edge detection metric is calculated by processing the second down-sampled frame using a directional decomposition to generate a set of directional components.

20. The method according to claim 17, wherein the motion metric comprises a sum of absolute differences between the first down-sampled frame and the second down-sampled frame.

21. The method according to claim 17, comprising generating the detail perception metric and determining the encoder parameter for each of a plurality of local blocks of the second down-sampled video frame.

22. The method according to claim 17, wherein the encoder parameter comprises a priority level for encoding resources.

23. The method according to claim 17, wherein the encoder parameter is a parameter for Low Complexity Enhancement Video Coding (LCEVC).

24. The method according to claim 23, wherein the encoder parameter comprises a residual mode selection for encoding a residual in an LCEVC enhancement layer when encoding the second frame.

25. The method according to claim 23, wherein the encoder parameter comprises a decision of whether or not to apply temporal prediction to an LCEVC enhancement layer when encoding the second frame.

26. The method according to claim 23, wherein the encoder parameter comprises a quantization parameter for an LCEVC enhancement layer when encoding the second frame.

27. A method of encoding an input video comprising a sequence of video frames, the input video having a first resolution, the method comprising:
obtaining a first and a second video frame of the input video, wherein the second video frame follows the first video frame in the sequence of video frames;
performing pre-analysis to determine an encoder parameter for encoding the second video frame; and
instructing an encoder to encode the second video frame based on the encoder parameter,
wherein the pre-analysis comprises:
obtaining a first and a second video frame of the input video, wherein the second video frame follows the first video frame in the sequence of video frames;
down-sampling the first and second frames to a second resolution to obtain a first and a second down-sampled video frame;
generating a detail perception metric based on the first and second down-sampled video frames; and
determining, based on the detail perception metric, an encoder parameter for encoding the second video frame,
wherein the detail perception metric comprises an edge detection metric based on the second down-sampled frame and a motion metric based on a difference between the first and second down-sampled frames.

28. The method according to claim 27, wherein the encoder is a Low Complexity Enhancement Video Coding (LCEVC) encoder, and encoding the second video frame comprises:
down-sampling the second video frame;
encoding the down-sampled second video frame using a base codec to obtain a base encoding layer;
decoding the base encoding layer using the base codec to obtain a decoded reference video frame;
calculating one or more residuals based on a difference between the second frame and the decoded reference video frame; and
encoding the one or more residuals to obtain an enhancement layer, wherein the encoder parameter is a parameter for calculating or encoding one or more of the residuals.

29. A device comprising
one or more processors;
a non-transitory memory, the memory storing executable instructions which, when executed by the processors, cause the device to perform the following:
obtain a first and a second video frame of the input video, wherein the second video frame follows the first video frame in the sequence of video frames;
down-sample the first and second frames to a second resolution to obtain a first and a second down-sampled video frame;
generate a detail perception metric based on the first and second down-sampled video frames; and
determine, based on the detail perception metric, an encoder parameter for encoding the second video frame,
wherein the detail perception metric comprises an edge detection metric based on the second down-sampled frame and a motion metric based on a difference between the first and second down-sampled frames.
